(19) United States
(12) Patent Application Publication
(10) Pub. No.: US 2026/0095396 A1
(43) Pub. Date: Apr. 2, 2026

(54) APPARATUSES, METHODS, AND COMPUTER PROGRAM PRODUCTS FOR TRANSFORMING AN INTERFACE DATA OBJECT ASSOCIATED WITH SERVER COMMUNICATIONS INTO A SERVER-BASED APPLICATION

(71) Applicant: ATLASSIAN PTY LTD, Sydney (AU)

(72) Inventor: Brett Dubroy, Sydney (AU)

(21) Appl. No.: 18/899,553

(22) Filed: Sep. 27, 2024

(51) Int. Cl. H04L 41/5009; H04L 43/045

(52) U.S. Cl. CPC H04L 41/5009; H04L 43/045

(57) ABSTRACT

Methods, apparatuses, or computer program products that provide for transforming an interface definition data object associated with server interface rules into a server-based application. In some examples, an interface definition data object that comprises a set of interface rules associated with managing communications between components of a multi-component system of an application framework is received, a particular computer-executable task from a plurality of computable-executable tasks is determined, the interface definition data object is transformed into a server-based application associated with a particular type of programming format, utilization of the server-based application via the multi-component system of the application framework is initiated, and performance of the multi-component system is monitored based at least in part on the server-based application.

### BACKGROUND

It is often difficult to manage and/or support components of a server system in which inputs, components, and/or data storage requirements of the server system dynamically change. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In various embodiments, an apparatus includes one or more processors and one or more storage devices storing instructions that are operable, when executed by the one or more processors, to cause the one or more processors to receive an interface definition data object that includes a set of interface rules associated with managing communications between components of a multi-component system of an application framework. In one or more embodiments, the instructions are additionally or alternatively operable, when executed by the one or more processors, to cause the one or more processors to determine a particular computer-executable task from a plurality of computable-executable tasks associated with the multi-component system of the application framework. In one or more embodiments, the instructions are additionally or alternatively operable, when executed by the one or more processors, to cause the one or more processors to transform the interface definition data object into a server-based application associated with a particular type of programming format from a plurality of programming formats based at least in part on (i) the set of interface rules and (ii) data associated with the particular computer-executable task. In one or more embodiments, the instructions are additionally or alternatively operable, when executed by the one or more processors, to cause the one or more processors to initiate utilization of the server-based application via the multi-component system of the application framework. In one or more embodiments, the instructions are additionally or alternatively operable, when executed by the one or more processors, to cause the one or more processors to monitor performance of the multi-component system based at least in part on the server-based application. In one or more embodiments, the instructions are additionally or alternatively operable, when executed by the one or more processors, to cause the one or more processors to monitor performance of the multi-component system based at least in part on the server-based application to generate a mapping of respective components of the multi-component system to the server-based application.

In one or more embodiments, the instructions are additionally or alternatively operable, when executed by the one or more processors, to cause the one or more processors to determine one or more utilization metrics associated with the utilization of the server-based application. In one or more embodiments, the instructions are additionally or alternatively operable, when executed by the one or more processors, to cause the one or more processors to initiate a rendering of a performance dashboard visualization via an electronic interface based at least in part on the one or more utilization metrics.

In one or more embodiments, the instructions are additionally or alternatively operable, when executed by the one or more processors, to cause the one or more processors to determine the one or more utilization metrics based at least in part on a definition version identifier associated with the server-based application.

In one or more embodiments, the instructions are additionally or alternatively operable, when executed by the one or more processors, to cause the one or more processors to determine the one or more utilization metrics based at least in part on the particular computer-executable task.

In one or more embodiments, the instructions are additionally or alternatively operable, when executed by the one or more processors, to cause the one or more processors to determine the one or more utilization metrics based at least in part on execution of a computer-executable task associated with one or more components of the multi-component system.

In one or more embodiments, the instructions are additionally or alternatively operable, when executed by the one or more processors, to cause the one or more processors to transform the interface definition data object into the server-based application based at least in part on a definition version identifier associated with the interface definition data object.

In one or more embodiments, the instructions are additionally or alternatively operable, when executed by the one or more processors, to cause the one or more processors to monitor the performance of the multi-component system based at least in part on one or more Service License Agreement (SLA) objectives associated with the application framework.

In one or more embodiments, the instructions are additionally or alternatively operable, when executed by the one or more processors, to cause the one or more processors to initiate the utilization of the server-based application based at least in part on a user input data object that defines one or more utilization behaviors associated with the server-based application.

In one or more embodiments, the instructions are additionally or alternatively operable, when executed by the one or more processors, to cause the one or more processors to execute the particular computer-executable task based at least in part on the server-based application.

In one or more embodiments, the instructions are additionally or alternatively operable, when executed by the one or more processors, to cause the one or more processors to initiate storage of the server-based application via a data repository that is accessible by one or more client devices communicatively coupled to the application framework.

In one or more embodiments, the instructions are additionally or alternatively operable, when executed by the one or more processors, to cause the one or more processors to retrieve the interface definition data object from a data repository that is accessible by one or more client devices communicatively coupled to the application framework.

In various embodiments, a computer-implemented method, includes receiving an interface definition data object that includes a set of interface rules associated with managing communications between components of a multi-component system of an application framework. In one or more embodiments, the computer-implemented method additionally or alternatively includes determining a particular computer-executable task from a plurality of computable-executable tasks associated with the multi-component system of the application framework. In one or more embodiments, the computer-implemented method additionally or alternatively includes transforming the interface definition data object into a server-based application associated with a particular type of programming format from a plurality of programming formats based at least in part on (i) the set of interface rules and (ii) data associated with the particular computer-executable task. In one or more embodiments, the computer-implemented method additionally or alternatively includes initiating utilization of the server-based application via the multi-component system of the application framework. In one or more embodiments, the computer-implemented method additionally or alternatively includes monitoring performance of the multi-component system based at least in part on the server-based application to generate a mapping of respective components of the multi-component system to the server-based application.

In one or more embodiments, the computer-implemented method additionally or alternatively includes determining one or more utilization metrics associated with the utilization of the server-based application; and initiating a rendering of a performance dashboard visualization via an electronic interface based at least in part on the one or more utilization metrics.

In one or more embodiments, the computer-implemented method additionally or alternatively includes determining the one or more utilization metrics based at least in part on a definition version identifier associated with the server-based application.

In one or more embodiments, the computer-implemented method additionally or alternatively includes determining the one or more utilization metrics based at least in part on the particular computer-executable task.

In one or more embodiments, the computer-implemented method additionally or alternatively includes determining the one or more utilization metrics based at least in part on execution of a computer-executable task associated with one or more components of the multi-component system.

In one or more embodiments, the computer-implemented method additionally or alternatively includes transforming the interface definition data object into the server-based application based at least in part on a definition version identifier associated with the interface definition data object.

In one or more embodiments, the computer-implemented method additionally or alternatively includes monitoring the performance of the multi-component system based at least in part on one or more SLA objectives associated with the application framework.

In one or more embodiments, the computer-implemented method additionally or alternatively includes initiating the utilization of the server-based application based at least in part on a user input data object that defines one or more utilization behaviors associated with the server-based application.

In various embodiments, a computer program product, stored on a computer readable medium, includes instructions that when executed by one or more computers cause the one or more computers to receive an interface definition data object that includes a set of interface rules associated with managing communications between components of a multi-component system of an application framework. In one or more embodiments, the computer program product additionally or alternatively includes instructions, that when executed by the one or more computers, cause the one or more computers to determine a particular computer-executable task from a plurality of computable-executable tasks associated with the multi-component system of the application framework. In one or more embodiments, the computer program product additionally or alternatively includes instructions, that when executed by the one or more computers, cause the one or more computers to transform the interface definition data object into a server-based application associated with a particular type of programming format from a plurality of programming formats based at least in part on (i) the set of interface rules and (ii) data associated with the particular computer-executable task. In one or more embodiments, the computer program product additionally or alternatively includes instructions, that when executed by the one or more computers, cause the one or more computers to initiate utilization of the server-based application via the multi-component system of the application framework. In one or more embodiments, the computer program product additionally or alternatively includes instructions, that when executed by the one or more computers, cause the one or more computers to monitor performance of the multi-component system based at least in part on the server-based application to generate a mapping of respective components of the multi-component system to the server-based application.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system within which one or more embodiments of the present disclosure may operate;

FIG. 2 is a block diagram of an example server-based application apparatus configured in accordance with one or more embodiments of the present disclosure;

FIG. 3 illustrates an example data flow related to a server-based application apparatus in accordance with one or more embodiments of the present disclosure;

FIG. 4 illustrates another example data flow related to a server-based application apparatus in accordance with one or more embodiments of the present disclosure;

FIG. 5 illustrates an example system associated with the server-based application apparatus in accordance with one or more embodiments of the present disclosure;

FIG. 6 illustrates another example system associated with the server-based application apparatus in accordance with one or more embodiments of the present disclosure;

FIG. 7 illustrates an example system associated with monitoring performance of a server-based application in accordance with one or more embodiments of the present disclosure;

FIG. 8 illustrates an example utilization of a server-based application via an application framework in accordance with one or more embodiments of the present disclosure;

FIG. 9 is a flowchart diagram for transforming an interface definition data object associated with server interface rules into a server-based application in accordance with one or more embodiments of the present disclosure; and

FIG. 10 is a flowchart diagram for monitoring performance of a server-based application associated with server interface functionality in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing server systems such as, for example, managing databases, components, and/or data objects for a server system. The disclosed techniques may be provided by an apparatus integrated with an application framework where multiple components/resources and/or layers of components/resources interact with one another in several complex manners to provide collaborative applications and/or collaborative services. Various embodiments of the present disclosure additionally or alternatively address technical problems associated with the generation and/or management of communications between components, services, and/or microservices of a server system.

An application framework (e.g., a cloud application framework) is typically characterized by a large number of the application components (e.g., services, microservices, and the like) that are offered by the application framework. Those application components typically include a large number of frontend application components and/or a large number of backend application components. One example application framework might include an enterprise instance of Jira®, an action tracking and project management software platform, developed by Atlassian Pty. Ltd. that may be licensed to Beta Corporation. Other software platforms may serve as application frameworks (e.g., Confluence®, Trello®, Bamboo®, Clover®, Crucible®, etc. by Atlassian Pty. Ltd) as will be apparent to one of ordinary skill in the art in view of the foregoing discussion.

Due to the scale and the numerosity of the application components, a large number of executable code may be generated for the application framework, for example, as a server-based application associated with the application framework. In some examples, the executable code may be server-to-server (S2S) code or another type of executable code. A server-based application may be executable via the application framework or via a virtual machine on a client device. Server-based applications may be generated based on interface specifications which may be non-code definitions that define contracts between one or more components. These specifications may directly represent the capabilities offered by a target component for a consuming component to use. Server-based applications may implement specifications, be generated for a variety of purposes, and may be difficult to manage due to the sheer volume of components and due to the complexity of the application framework. For example, the application framework may be configured as a collaborative application framework and defined executable code may be required to handle processing of events, incidents, changes, component requests, alerts, notifications, workflows, service requests, service tickets, and/or other dynamic data related to the collaborative application framework. The server-based applications used by an application framework may also relate to a business or enterprise that has deployed or licensed the application framework for managing events, incidents, changes, component requests, alerts, notifications, workflows, service requests, service tickets, and/or other dynamic data. Additionally, to further add to the complexity of the application framework, defined executable code may comprise various programming languages. For example, one specification may be utilized for two or more server-based applications where each server-based application comprises a different programming language.

To manage the scale, numerosity, and/or complexity of the defined executable code of an application framework, a client device (e.g., a client device utilized by a user such as, for example, a developer) may be utilized to generate one or more portions of an application based on a specification. For example, a client device may be utilized by a developer to write and/or update one or more server-based applications to interface with one or more components of an application framework, provide new functionalities, keep up with security standards, protocols, and/or the like. However, utilizing a client device to generate a server-based application introduces the risk of human errors, network security vulnerabilities, inefficiencies with respect to an application framework, and/or excessive computing resources for configuring server-based applications.

Moreover, by utilizing a client device to configure one or more server-based applications associated with an application framework, it may be difficult to manage defined executable code and/or server-based applications given the complexity and scale of modern application frameworks. For example, it may be difficult to keep server-based applications up to date, ensure server-based applications can meet dynamic needs of an application framework, ensure server-based applications will be successfully generated from specifications, and/or the like by utilizing a client device to configure one or more server-based applications associated with an application framework. Additionally, it may be difficult to provide traceability across the application framework, for example, to identify server-based applications that are out of date, diagnose issues with server-based applications and/or specifications, ensure compliance with service license agreements (SLA) targets, and/or the like by utilizing a client device to configure one or more server-based applications associated with an application framework. It may also be difficult to handle routing data structures and requests between application components using server-based applications that cannot perform dynamic targeting by utilizing a client device to configure one or more server-based applications associated with an application framework. For example, in an application framework with many components and versions of components, a user may not know a specific uniform resource locator (URL) to configure a server-based application to target. In a non-limiting example, consider a scenario in which it is desirable for Beta Corporation to manage collaborative portions of a service management process such as, for example, an information technology service management process (or another type of application component process) such that respectively components are automatically processed, routed, and/or stored in a distributive manner across databases. However, the services management processes and/or workflows may result in a vast and complex collection of data related to various services, resulting in difficulties for tracing data objects, inefficient usage of computing resources, and/or other technical drawbacks.

To address the above-described challenges and/or technical problems related to managing server systems and/or an application framework, various embodiments of the present disclosure are directed to systems, apparatuses, methods, and/or computer program products for providing automatic generation and/or improved functionality of server-based applications associated with an application framework. In various embodiments, the automatic generation and/or functionality of server-based applications disclosed herein is utilized to provide traceability and standardization for executable code between components of an application framework. In various embodiments, the server-based application functionality may be integrated within an application framework system.

In various embodiments, systems, apparatuses, methods, and/or computer program products provide a tool to translate definitions for executable code into one or more code artifacts for an application framework. The definitions may be, for example, interface definitions to facilitate interfacing communications between components of an application framework. In various embodiments, the definitions may be transformed between various types of programming formats. The executable code associated with the definitions may also be published for utilization by one or more components of an application framework. In various embodiments, one or more potential issues that may be introduced in one or more downstream services may be identified in response to utilization of the executable code associated with the definitions via an application framework.

In various embodiments, the automatic generation and/or functionality of server-based applications disclosed herein may be agnostic of respective configurations (e.g., different configurations) of underlying components and/or services of an application framework, enabling easy and flexible adoption of the server-based applications within the application framework. For example, the application functionality may allow server-based applications to be adopted for components in an application framework that includes heterogeneous components (e.g., numerous heterogeneous services and/or microservices). The application functionality may also provide standardized server-based applications that are easily and individually configurable to meet the dynamic technical requirements of various components (e.g., services or microservices) within an application framework. For example, a server-based application generated for a component may be configured to provide functionalities such as server interface functionality associated with an application framework, management of Hypertext Transfer Protocol (HTTP) data (e.g., HTTP cookies, etc.) associated with an application framework, configuration of data packets for identifying client devices and/or components associated with data requests, dynamic targeting, management of network connection properties, metrics observations, histogram-based egress metrics, additional metric tags, automatic error exception unwrapping, circuit breaking associated with server-based applications, retry logic associated with server-based applications, rate limiting associated with components of an application framework, and/or the like.

In various embodiments, the automatic generation and/or functionality of server-based applications disclosed herein may provide traceability of executable code, specifications, and/or server-based applications to support compliance with server deployment strategies, resiliency against system failures, etc. In various embodiments, the automatic generation and/or functionality of server-based applications disclosed herein may enable external systems to capture monitoring data indicating which server-based application is utilized to handle a particular interface communication (e.g., an API call), which specification version is utilized to generate a respective server-based application, and which components are associated with the particular interface communication, etc. In some examples, the automatic generation and/or functionality of server-based applications disclosed herein may enable external systems to track the adoption of updates. For example, an update to a new specification version necessary for compliance with an SLA, security protocol, and/or the like, may be traceable using the server-based application functionality described herein to identify which components of an application framework have adopted the update. In various examples, the automatic generation and/or functionality of server-based applications disclosed herein may provide the ability to trace errors and metrics describing interface communications within an application framework. For instance, if an unknown error is occurring in association with a component of an application framework, the automatic generation and/or functionality of server-based applications disclosed herein may enable a visualization associated with interface communication traffic and/or performance associated therewith, thereby providing valuable insights into the interface communications and for resolving such errors. In some embodiments, the visualization may enable identification of a particular error, specification version, and/or component with respect to a particular server-based application.

In various embodiments, the automatic generation and/or functionality of server-based applications disclosed herein may provide improved scalability of interface communications for components and/or may reduce the cost of computing resources associated with an application framework. For example, the application functionality may automatically generate defined executable code in less amount of time and/or with improved quality as compared to a human developer, thereby improving scalability of interface communications for components and/or reducing the cost of computing resources associated with an application framework.

In various embodiments, the automatic generation and/or functionality of server-based applications disclosed herein may enable improved interface communications associated with components of an application framework. In various embodiments, the automatic generation and/or functionality of server-based applications disclosed herein may additionally or alternatively enable utilization of a pre-generated application for a component and/or dynamic configuration of a server-based application based on a set of user preferences. In contrast, a traditional system that lacks the server-based application functionality described herein may require a human developer to identify a specification, generate a particular instantiation of the specification, and/or hard code a target URL for a server-based application prior to execution of interface communication. Additionally, the automatic generation and/or functionality of server-based applications disclosed herein may minimize client device interactions with respect to an application framework to maintain and/or update executable code for server-based applications and/or components. For example, server-based applications of an application framework disclosed herein may be automatically updated, tested, and/or published for utilization via the application framework.

In various embodiments, efficiency, functionality, and/or cost of computing resources with respect to processing and/or managing interface communications for the application framework may be improved by employing the automatic generation and/or functionality of server-based applications disclosed herein to manage executable code related to an application framework. In doing so, various embodiments of the present disclosure make substantial technical contributions to improving the efficiency and/or the effectiveness of an application framework. Various embodiments of the present disclosure additionally or alternatively provide improved resiliency, management, and efficiency of data management, improved cross-product collaboration, improved scalability, improved service stability, improved usability, improved data quality, and/or improved interactions with respect to data related to an application framework.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network. ” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “component” or “application component” refers to a computer functionality or a set of computer functionalities, such as the retrieval of specified information or the execution of a set of operations, with a purpose that different clients may reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component may represent an operation with a specified outcome and may further be a self-contained computer program. In some embodiments, a component from the perspective of the client (e.g., another component, application, etc.) may be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service (e.g., a web service). Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework. The term “component object identifier” refers to one or more data items or elements by which a component object may be uniquely identified. The component object identifier may include, for example, one or more of Internet Protocol (IP) addresses associated with a component, Uniform Resource Locators (URLs) associated with a component, numerical characters, alphabetical characters, alphanumeric codes, American Standard Code for Information Interchange (ASCII) characters, encryption keys, identification certificates, the like, or combinations thereof. An example embodiment of a component object identifier may comprise data provided by at least a component author, for example, a URL and a payload associated with a component. In some embodiments, the payload comprises a JSON formatted text that is either posted, by way of an HTTP POST, to a component when a resource is created or returned from a component, through an HTTP GET, when at least a resource is requested from the component.

The term “application framework” refers to a computing environment associated with one or more computing devices and one or more components (e.g., one or more application components), where the environment enables interactions with respect to components supporting at least one application. For example, an application framework may be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components may support the application over one or more communication networks. The application framework may include one or more components to generate and update a repository of collected information for each component (e.g., an event object repository). Accordingly, the application framework may provide for the collection of information, in the form of event objects, to facilitate monitoring of event streams associated with one or more components of the application framework. In certain embodiments, the application framework may be configured as a collaborative application framework that manages one or more collaborative applications such as, for example, one or more collaborative document applications, collaborative software development applications, and/or one or more other types of collaborative applications. In certain embodiments, the application framework may be configured as an enterprise instance of a collaboration and knowledge base component platform for managing documents and/or encouraging collaboration among users. In certain embodiments, the application framework may be configured as a service management software platform. In certain embodiments, the application framework may alternatively be configured to manage one or more project management applications, one or more work management applications, one or more software development applications, one or more product development applications, one or more portfolio management applications, or one or more other types of applications. In certain embodiments, the application framework may be configured as an enterprise instance of an information technology service management software platform. However, it is to be appreciated that, in other embodiments, the application framework may be configured as another type of component platform.

The term “application framework system” refers to a system that includes both a server framework and a repository framework to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application may be supported by one or more components either via direct communication with the component or indirectly by relying on a component that is in turn supported by one or more other components.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “dependency relationship” or similar terms refer to an exchange of data and/or functionality between a first component and a second component. For example, the first component may be directly dependent upon the second component for a DNS lookup. In some embodiments, the second component may be directly dependent upon a third component whereby the first component is transitively dependent upon the third component via the second component. As such, the dependency relationship may be a direct relationship comprising two components or it may be a transitive relationship comprising a plurality of components. In some embodiments, a first component and a second component may have a plurality of dependency relationships between them. For example, the second component may perform both a lookup and access log function for the first component.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components may be collected and compiled into component objects which may also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more APIs. For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “consuming component” refers to a component using a service-based application. For example, a consuming component may leverage a service-based application to perform one or more computer-executable tasks. In some examples, a consuming component may configure a service-based application to include appropriate dependencies, utilization behaviors, and/or the like necessary for being used by the consuming component. In various examples, a consuming component may configure and/or use a service-based application to interact with a target component.

The term “target component” refers to a component that is the target of a computer-executable task performed by a service-based application. For example, a service-based application may be used by a consuming component to perform a computer-executable task associated with a target component. In various examples, a target component may respond to a service-based application.

The term “programming format” refers to a particular programming language used in association with an application framework. For example, a programming format may be any programming language used to write computer-executable code including, but not limited to Java, JavaScript, TypeScript, Go, Python, C #, C++, Ruby, PHP, Rust, and/or the like.

The term “interface definition data object” refers to a data entity that defines and/or describes a contract, specification, and/or the like, for one or more interactions associated with an application framework. For example, an interface definition data object may define how a computer executable task (e.g., a S2S communication) should be implemented for a component of an application framework. In some examples, an interface definition data object may be used to specify how one or more components of an application framework may transmit and/or receive data. In some examples, an interface definition data object may comprise one or more interface rules. For example, one or more interface rules may be used to specify the contract, specification, and/or the like, defined and/or described by an interface definition data object. By way of example, in some embodiments, an interface definition data object may include or otherwise be associated with OpenAPI specification, JSON Schema, Protocol Buffer (Protobuf), API Blueprint, RESTful API Modeling Language (RAML), and/or the like. In various examples, interface definition data object may be stored within and/or retrieved from one or more interface definition data object repositories.

In various embodiments, an interface definition data object may be associated with one or more server-based applications, components, computer-executable tasks, teams, individuals, and/or the like. For example, an interface definition data object used to generate a server-based application may be associated with the server-based application and traceable to the server-based application. Additionally or alternatively, the interface definition data object may be traceable to one or more computer-executable tasks and/or components associated with downstream actions of the server-based application. In various examples, an interface definition data object may be associated with one or more individuals and/or teams (e.g., developers). For example, issues, updates, and/or the like, associated with the interface definition data object may result in alerts to one or more individuals and/or teams associated with the interface definition data object (e.g., creators of the interface definition data object, users of the interface definition data object, etc.). In some examples, an interface definition data object may be updated and/or modified. For example, an interface definition data object may be updated to describe and/or provide new and/or changed functionalities, adhere to changed standards (e.g., SLAs, security protocols, etc.), provide new configurations, and/or the like.

In some embodiments, an interface definition data object may include or otherwise be associated with a definition version identifier indicative of the particular configuration of the interface definition data object. In some examples, a definition version identifier may be associated with an interface definition data object based on the particular configuration of the interface definition data object. In one example, an interface definition data object associated with a definition version identifier (e.g., a version number 1.0.1) may be updated to comprise a new configuration that enables a new functionality for some S2S communication, and, as a result, the updated interface definition data object comprising a new configuration may be associated with a different definition version identifier (e.g., a version number 1.0.2). In this manner, different configurations of an interface definition data object may be stored, tracked, managed, and/or the like. In various examples, an implementation of an interface definition data object may also be associated with a definition version identifier of the interface definition data object. For example, a server-based application may be associated with a particular definition version identifier (e.g., a release date 2024 Aug. 11) because the server-based application is implemented from an interface definition data object associated with the same particular definition version identifier (e.g., the release date 2024 Aug. 11).

In certain embodiments, an interface definition data object may be configured to be agnostic of a programming format. In this manner, an interface definition data object may be implemented using a various programming formats. For example, an interface definition data object may be implemented as a plurality of server-based applications where each server-based application is associated with a different programming format.

The term “interface rule” refers to a data entity defining one or more components, parameters, contents, and/or the like, of an interface definition data object. For example, the set of interface rules of an interface definition data object may comprise the contract, specification, and/or the like, defined and/or described by an interface definition data object. Additionally or alternatively, interface rules may define one or more parameters, values, conditions, objects, and/or the like, for the implementation of an interface definition data object and/or the generation of a server-based application. By way of example, an interface rule may include, be associated with, and/or otherwise define metadata, a definition version identifier, servers, paths, data types, formats, objects, parameters, required parameters, optional parameters, query parameters, requests, responses, inputs, outputs, authenticators, extensions, tags, links, and/or the like. In various examples, interface rules may be configured to outline various functionalities for implementations of interface definition data objects.

The term “server-based application” refers to an implementation of an interface definition data object. For example, a server-based application may be a data entity configured according to an interface definition data object that facilitates one or more computer-executable tasks (e.g., interactions, S2S communications, API calls, etc.) associated with one or more components of an application framework. A server-based application may implement an interface definition data object using a particular programming format. Various server-based applications may comprise different programming formats. In some examples, a server-based application may be associated with a particular one or more computer-executable tasks for which the server-based application is configured to facilitate with respect to a particular one or more components. Additionally or alternatively, a server-based application may be associated with one or more interface definition data objects, components, individuals, teams, and/or the like. For example, a server-based application may be associated with and/or traceable to an interface definition data object that the server-based application was generated from. Additionally or alternatively, a server-based application may be associated with and/or traceable to components (e.g., consuming components, target components, etc.) that the server-based application interacts with. Additionally or alternatively, a server-based application may be associated with one or more individuals and/or teams (e.g., developers). For example, issues, updates, and/or the like, associated with the server-based application may result in alters to one or more individuals and/or teams associated with the server-based application (e.g., users of the server-based application). In various examples, server-based applications may be stored within and/or retrieved from one or more server-based application repositories.

In various embodiments, a server-based application may comprise a standardized configuration based on a respective interface definition data object. In some examples, a server-based application may be configurable to meet dynamic needs of a particular combination of one or more programming formats, computer-executable tasks, components, protocols, standards, SLAs, and/or the like. For example, a server-based application may comprise one or more configurable parameters (e.g., utilization behaviors) that control functionalities and/or the performance of the server-based application. In various examples, a server-based application may be configurable by a user. For example, user inputs may be used to define one or more utilization behaviors to change the functionalities and/or performance of the server-based application.

In some embodiments, a server-based application may be used to facilitate standardized, reliable, and efficient computer-executable tasks between components of an application framework. By way of example, a server-based application may be used to interface with an API more easily. For example, a server-based application may be automatically generated from an interface definition data object and provide, for example, a set of functions and/or methods to make API calls, handle API responses, handle errors and/or exceptions, and/or the like. In various examples, a server-based application may be generated in association with particular computer-executable tasks, particular APIs, particular consuming components, particular target components, and/or the like, and/or some combination thereof.

In certain embodiments, data associated with the performance and/or utilization of a server-based application may be recorded. For example, utilization metrics associated with a server-based application may be recorded by the server-based application, one or more associated components, and/or the like. In various examples, data associated with a server-based application (e.g., utilization metrics) may be used to monitor the performance of a server-based application with respect to an application framework. For example, traffic statistics, S2S communications, troubleshooting, debugging, descriptive and/or predictive data modeling, and/or the like, may be performed and/or facilitated by monitoring the performance and/or utilization of server-based applications. In various examples, data identifying a particular server-based application (e.g., an identifier), a particular type of a server-based application (e.g., whether the server-based application is reactive or not), and/or the like, may be recorded. In some examples, a server-based application may be associated with an identifier that identifies the particular server-based application as well as an identifier (e.g., a definition version identifier) that identifies the interface definition data object that the server-based application implements. In various examples, a definition version identifier of a particular interface definition data object may be linked to a particular server-based application (e.g., using an identifier associated with the server-based application). Additionally or alternatively, a particular service-based application may be linked to a particular consuming component (e.g., a component that uses the service-based application) which may be further linked to a particular target component (e.g., a component that was interacted with by the consuming component via the server-based application. In this manner, embodiments described herein may provide for traceability of an interface definition data object, server-based application, consuming component, and/or target component for various computer-executable tasks associated with an application framework.

In various embodiments, a server-based application may be associated with standardized documentation (e.g., documentation as code) to describe the server-based application and how to use the server-based application. For example, a document associated with a server-based application may describe the computer-executable tasks, utilization behaviors, components, and/or the like, that are associated with the server-based application such that a user may easily identify how and/or for which reasons a server-based application may be used. In various examples, standardize documentation associated with server-based applications may be used to list which server-based applications are available according to various parameters (e.g., an up-to-date list of available server-based applications for a particular technology stack). In some examples, standardized documentation associated with a server-based application may be generated by the server-based application generator.

In some embodiments, a server-based application may be generated automatically from an interface definition data object. For example, an interface definition data object may be published to an interface definition data object repository and/or the like from which the server-based application generator of an application framework is configured to automatically generate server-based applications. In various examples, server-based application may be automatically published to a server-based application repository and/or the like from which users may view, retrieve, and/or use the server-based applications. For example, a server-based application automatically generated from an available interface definition data object may be tested (e.g., by the server-based application performance monitor) for functionality and, in response to satisfying such testing, be published to a server-based application repository and made available for retrieval (e.g., published to a website as a file available for download).

The term “computer-executable task” refers to an operation, functionality, set of functionalities, interaction, and/or the like, for which a computing device may be applied. For example, a computer-executable task may include or otherwise be associated with transmitting, receiving, and/or storing of data for some respective purpose. In some examples, a computer-executable task may be an API call, API response, and/or the like. By way of example, a computer-executable task may be one or more data-based operations including, but not limited to, creating, reading, updating, deleting (CRUD), searching, filtering, processing, notifying, altering, reporting, receiving, configuring, setting, error handling, authenticating, authorizing, and/or the like. In various examples, computer-executable tasks may be used to perform various interactions for an application framework such as, for example, S2S communications, providing data to component, receiving data from a component, adding new resources to a repository, retrieving existing resources from a repository, providing user credentials to a component for authentication, processing data to generate and/or provide results, providing data for processing to receive results, performing searches based on received criteria to provide results, applying filters based on received criteria to provide results, providing alerts in response to conditions, applying configurations to data objects, extending communications to third-party services, logging errors, generating reports, and/or the like.

The term “utilization behavior” refers to a configurable parameter, feature, functionality, and/or the like, of a server-based application. For example, a utilization behavior may be a configurable to change one or more functionalities and/or the performance of a server-based application. By way of example, a utilization behavior may configure how a server-based application handles cookies, headers, tags, routing (e.g., enable dynamic targeting for communications made by the server-based application), connection pools, circuit breakers, rate limiters, retry functionalities, errors and/or exceptions, utilization metrics, and/or the like.

In some embodiments, a utilization behavior may configure how a server-based application handles headers of an API-based computer-executable task. For example, a server-based application configured to service API calls may comprise a utilization behavior used to add, remove, and/or modify particular headers associated with API calls. In one example, a utilization behavior may be used to modify cookies (e.g., disable all cookies) for API calls handled by a server-based application. In another example, a utilization behavior may be used to modify headers that identify communications (e.g., API calls, API responses) as being generated by a server-based application. For example, such a header may identify an API call made by a server-based application as being generated by a server-based application (e.g., a server-based application automatically generated by the server-based application generator) and may further identify the API call as being generated by a particular type associated with a server-based application. In some examples, a server-based application may be a Java Virtual Machine (JVM) application or another type of server-based application.

In certain embodiments, a utilization behavior may configure how a server-based application determines an identifier for a target component of a computer-executable task. For example, a utilization behavior may be used to enable a server-based application to perform dynamic targeting of components, endpoints, and/or the like. In some examples, such a utilization behavior may enable a user to dynamically provide a target identifier for a server-based application by specifying a hostname (e.g., on a per-request basis that can be determined at each call site) instead of a fixed target identifier (e.g., a URL). For example, a functionality used to store fixed target identifiers in a per-request, secure manner may be leveraged such that fixed target identifiers may be retrieved and applied to a computer-executable task (e.g., an API call) just before the computer-executable task is executed. In this manner, the server-based applications described herein may be used in application frameworks that utilize sharding (e.g., multiple shards in a region) and/or multi-region scenarios.

In some embodiments, a utilization behavior may configure how a server-based application performs computer-executable tasks based on errors, traffic volumes, and/or the like. For example, a utilization behavior may configure how a server-based application determines various communication parameters. In some examples, a utilization behavior may be used to control connection pool configurations for a server-based application to, for example, specify a maximum and/or minimum number of connections to a resource. In various examples, utilization behaviors associated with connection pool configurations may be used for a server-based application regardless of a type of the server-based application (e.g., whether the server-based application is a reactive type or not). In some examples, a utilization behavior may configure a server-based application to enable a circuit breaker functionality to, for example, prevent the server-based application from repeatedly trying to execute a task (e.g., a computer-executable task), for example, if the task is likely to fail, has already failed a number of times exceeding a threshold, and/or the like. In another example, a utilization behavior may configure a server-based application to enable a rate limiter functionality to, for example, limit a volume and/or rate of computer-executable tasks (e.g., API calls) processed by a server-based application. In another example, a utilization behavior may configure a server-based application to perform various error exceptions. For example, a utilization behavior may configure a server-based application to decode an error and/or exception to retrieve details associated with the error and/or exception, thereby enabling a server-based application to fine-tune handling of such errors and/or exceptions. In some examples, a utilization behavior may configure a server-based application to handle certain errors and/or exceptions according to various functionalities while ignoring other certain errors and/or exceptions.

In various embodiments, a utilization behavior may configure how a server-based application manages utilization metrics. For example, utilization metrics may be associated with and/or managed by utilization behaviors. In some examples, a utilization behavior may be used to configure a server-based application to record utilization metrics. For example, a utilization behavior may turn on or off certain utilization metrics (e.g., various metric tags). In some embodiments, a utilization behavior may configure a server-based application to span, integrate, overwrite, and/or modify underlying technologies, standards, and/or the like.

The term “utilization metric” refers to a data entity indicative of a performance associated with an application framework. In various examples, a utilization metric may identify various associations between computer-executable tasks (e.g., interactions, S2S communications, API calls, etc.), components (e.g., consuming components, target components, etc.), server-based application, identifiers, interface definition data objects (e.g., via definition version identifiers), and/or the like. By way of example, utilization metrics associated with a server-based application may be used to identify a particular computer-executable task (e.g., a particular API call) as being associated with the server-based application, a particular consuming component that used the server-based application, a particular target component the server-based application interacted with, a particular interface definition data object used to generate the server-based definition, the particular data comprised within a particular computer-executable task (e.g., a particular S2S communication) facilitated by the server-based application, metadata associated with a particular computer-executable task facilitated by the server-based application, and/or the like. In some examples, utilization metrics may be enabled for a particular component (e.g., a target component). In various examples, interceptors, encoders, decoders, error decoders, and/or the like may be used with a server-based application and/or one or more components to track and/or store utilization metrics.

In some embodiments, utilization metrics may be used to generate dashboard visualizations such as various descriptive and/or predictive data models, statistics, data visualizations, and/or the like. For example, utilization metrics may describe timers (e.g., how long a computer-executable task takes to complete such as an API call, a page rendering, etc.), data sizes (e.g., the size of API responses, downloads, etc.), interaction metrics (e.g., interactive elements of a web-page being used, components being used, server-based applications being used, etc.), errors (e.g., a number and/or type of errors, failed API calls, etc.), and/or the like. In various examples, utilization metrics may be used to generate dashboard visualizations such as histograms, heatmaps, line graphs, pie charts, rates, analytics, measures, and/or the like. In one example, a server-based application may be configurable (e.g., using utilization behaviors and/or utilization metrics) to generate a histogram of the traffic associated with the server-based application.

In various embodiments, utilization metrics may be associated with and/or managed by utilization behaviors. For example, a utilization behavior may be used to configure a server-based application to record utilization metrics. In various examples, a utilization metric associated with a server-based application may be a metric tag. For example, a server-based application may use a metric tag that automatically includes an identifier (or some other data) associated with the server-based application when the server-based application executes a computer-executable task (e.g., an API call).

The term “server-based application generator” refers to a data entity configured to generate server-based applications from interface definition data objects. For example, the server-based application generator may be an automatic code generator that parses interface definition data objects, analyzes the interface definition data object, and transforms the interface definition data object into a server-based application. In various examples, a server-based application generator may generate a server-based application from an interface definition data object based on a particular programming format, computer-executable task, component, and/or the like. For example, a server-based application generator may receive a particular interface definition data object and generate a server-based application to perform a particular computer-executable task associated with a particular component using a particular programming format. In some examples, the server-based application generator may include and/or otherwise be associated with the server-based application performance monitor.

In some embodiments, a server-based application generator may be configured to automatically generate server-based applications from interface definition data objects. For example, the server-based application generator may automatically receive and/or retrieve interface definition data objects from a repository (e.g., an interface definition data object repository, a server-based application repository) and generate server-based applications (e.g., on a defined schedule). In some examples, a repository (e.g., an interface definition data object repository, a server-based application repository) comprising interface definition data objects and/or server-based applications may be accessible to one or more users associated with the application framework. In some examples, interface definition data objects may be provided to an interface definition data object repository monitored by the server-based application generator such that the server-based application generator may automatically generate server-based applications from interface definition data objects upon being provided to the interface definition data object repository. In other examples, the server-based application generator may be tasked with generating a server-based application from a particular interface definition data object. In various examples, the server-based application generator may publish, store, and/or otherwise make available server-based applications. For example, the server-based application generator may store a server-based application via a server-based application repository accessible by users associated with the application framework.

In some embodiments, the server-based application generator may generate server-based applications in association with a particular component. For example, interface definition data objects may be associated with particular components (e.g., a target component) that server-based applications generated therefrom are configured to interact with. Accordingly, a particular component may have one or more interface definition data object registered with the particular component and the server-based application generator may be configured to generate server-based applications for any interface definition data objects registered with the particular component. In this manner, a user (e.g., a developer) may identify a target component for a computer-executable task (e.g., establish one or more API interactions with the target component) and, in response, the server-based application generator may generate and make available a server-based application for the computer-executable task. In various examples, the server-based application generator may automatically identify an interface definition data object (e.g., from an interface definition data object repository) or may be provided an interface definition data object (e.g., from the user).

In various embodiments, the server-based application generator may be used within an application framework to provide standardized code generation (e.g., server-based applications), logging (e.g., recording data), performance monitoring (e.g., utilization metrics, tracking data, etc.), testing (e.g., via the server-based application performance monitor), externalized configuration support (e.g., utilization behaviors), dynamic per-request set and/or override values (e.g., target component identifiers, dynamic routing, etc.), providing multiple use cases for a target component (e.g., generating multiple server-based applications for various use cases associated with a target component), and/or the like.

The term “server-based application performance monitor” refers to a data entity configured to process interface definition data objects and/or server-based applications. In some examples, the server-based application performance monitor may be used to automatically test interface definition data objects and/or server-based applications (e.g., against one or more defined performance criteria, using a diagnostic operation, etc.) and perform one or more actions based thereon. For example, the server-based application performance monitor may be configured to automatically test interface definition data objects on a continuous basis over a time interval to detect faults.

In some embodiments, the server-based application performance monitor may automatically perform one or more actions in response to an interface definition data object and/or server-based application failing to satisfy defined performance criteria. For example, in response to an interface definition data object failing to satisfy defined performance criteria, the server-based application performance monitor may modify one or more portions of the interface definition data object and/or a respective server-based application. Similarly, in response to a server-based application failing to satisfy defined performance criteria, the server-based application performance monitor may modify one or more portions of the server-based application and/or a respective interface definition data object. For example, the server-based application performance monitor may be configured to identify one or more portions of an interface definition data object and/or server-based application that are associated with the interface definition data object and/or server-based application failing to satisfy defined performance criteria. In such an example, the server-based application performance monitor may be further configured to modify the one or more respective portions of the interface definition data object and/or server-based application. In some examples, by modifying a portion of an interface definition data object and/or server-based application, the server-based application performance monitor may edit one or more portions of an interface definition data object and/or server-based application to resolve an issue, error, typo, unexpected behavior, inefficiency, and/or the like. In various examples, by modifying a portion of an interface definition data object and/or server-based application, the server-based application performance monitor may leave feedback descriptive of one or more portions of an interface definition data object and/or server-based application that should be reviewed and/or modified by another entity (e.g., a developer associated with the interface definition data object).

In some embodiments, the server-based application performance monitor may be configured to restrict the use of an interface definition data object and/or server-based application. For example, in response to a determination that an interface definition data object and/or server-based application fails to satisfy defined performance criteria, the server-based application performance monitor may be configured to restrict the use of a respective interface definition data object and/or server-based application within an associated repository (e.g., an interface definition data object repository, a server-based application repository), indicate that use of a respective interface definition data object and/or server-based application should be suspended, and/or the like. By way of example, in response to a determination that an interface definition data object and/or server-based application fails to satisfy defined performance criteria, the server-based application performance monitor may provide information to a repository identifying a respective interface definition data object and/or server-based application.

In response to a determination that an interface definition data object and/or server-based application fails to satisfy defined performance criteria, the server-based application performance monitor may additionally or alternatively provide instruction to a repository to restrict access to and/or the processing of a respective interface definition data object and/or server-based application. In response to a determination that an interface definition data object and/or server-based application fails to satisfy defined performance criteria, the server-based application performance monitor may additionally or alternatively flag a respective interface definition data object and/or server-based application. In response to a determination that an interface definition data object and/or server-based application fails to satisfy defined performance criteria, the server-based application performance monitor may additionally or alternatively alert one or more components and/or other entities to stop using a respective interface definition data object and/or server-based application. In response to a determination that an interface definition data object and/or server-based application fails to satisfy defined performance criteria, the server-based application performance monitor may additionally or alternatively remove a respective interface definition data object and/or server-based application from a repository. In response to a determination that an interface definition data object and/or server-based application fails to satisfy defined performance criteria, the server-based application performance monitor may additionally or alternatively restrict access to a respective interface definition data object and/or server-based application in a different manner.

Additionally or alternatively, in response to a determination that an interface definition data object and/or server-based application fails to satisfy defined performance criteria, the server-based application performance monitor may provide information indicative and/or descriptive of one or more particular workflows that may be negatively impacted by the use of a respective interface definition data object and/or server-based application such that the use of the respective interface definition data object and/or server-based application may be restricted with respect to only the one or more particular workflows. For example, the server-based application performance monitor may indicate a particular one or more components, a particular one or more tasks, a particular programming format, and/or the like, that may be negatively impacted by using a respective interface definition data object and/or server-based application that failed to satisfy defined performance criteria such that the use of the respective interface definition data object and/or server-based application may be restricted with respect to only the particular one or more components, the particular one or more tasks, the particular programming format, and/or the like.

In various embodiments, the server-based application performance monitor may be configured to render one or more dashboard visualizations in response to an interface definition data object and/or server-based application failing to satisfy defined performance criteria. For example, one or more dashboard visualizations may be used to provide descriptive and/or predictive data such as which interface definition data object and/or server-based application failed to satisfy defined performance criteria, which portions of an interface definition data object and/or server-based application failed to satisfy defined performance criteria, which components may be impacted by an interface definition data object and/or server-based application that failed to satisfy defined performance criteria, which corrective measures should be taken to address an interface definition data object and/or server-based application that failed to satisfy defined performance criteria, which entities should be alerted in response to an interface definition data object and/or server-based application that failed to satisfy defined performance criteria, and/or the like.

In some embodiments, the server-based application performance monitor may automatically perform one or more actions in response to an interface definition data object and/or server-based application satisfying defined performance criteria. In some examples, the server-based application performance monitor may be configured to perform continuous testing of an interface definition data object and/or server-based application. For example, in response to an interface definition data object and/or server-based application satisfying defined performance criteria, the server-based application performance monitor may repeatedly determine whether the respective interface definition data object and/or server-based application satisfies defined performance criteria (e.g., by repeatedly testing the respective interface definition data object and/or server-based application based on a time interval, updates to the defined performance criteria, updates to the respective interface definition data object and/or server-based application, etc.).

In some embodiments, the server-based application performance monitor may compare performance of two or more interface definition data objects and/or server-based applications with respect to defined performance criteria. For example, the server-based application performance monitor may transform an interface definition data object comprising one set of interface rules into a server-based application and transform another interface definition data object comprising another set of interface rules into another server-based application and compare the performance of the two server-based applications using defined performance criteria. In some examples, the interface definition data objects used in a comparison may be different interface definition data objects, different versions of the same interface definition data object, and/or the like. In various examples, the server-based application performance monitor may restrict the use of, block the use of, restrict access to, alert components and/or other entities to stop using, flag, and/or the like, an interface definition data object and/or server-based application in response to a determination that the respective interface definition data object and/or server-based application performs worse than another interface definition data object and/or server-based application in a comparison. In some examples, the server-based application performance monitor may be configured to render one or more dashboard visualizations in response to an interface definition data object and/or server-based application performing worse in a comparison. For example, one or more dashboard visualizations may be used to provide descriptive and/or predictive data such as which interface definition data object and/or server-based application performed worse in a comparison, which portions of an interface definition data object and/or server-based application performed worse in a comparison, which components may be impacted by an interface definition data object and/or server-based application performing worse in a comparison, various utilization metrics which may be impacted by an interface definition data object and/or server-based application performing worse in a comparison, which corrective measures should be taken to address an interface definition data object and/or server-based application performing worse in a comparison, and/or the like.

In various embodiments, the server-based application performance monitor may use a server-based application to perform a particular computer-executable task to determine if the server-based application satisfies defined performance criteria. For example, the server-based application performance monitor may determine one or more particular computer-executable tasks to perform using a particular server-based application and monitor the performance of the server-based application to determine whether the server-based application satisfies defined performance criteria associated with the particular computer-executable task. In various examples, the server-based application performance monitor may certify, publish, make available for use, continuously test, and/or the like, a server-based application in response to the server-based application satisfying defined performance criteria associated with a particular computer-executable task. In some examples, the server-based application performance monitor may block and/or otherwise stop the use of the server-based application in response to the server-based application failing to satisfy defined performance criteria associated with a particular computer-executable task. Additionally or alternatively, in response to the server-based application failing to satisfy defined performance criteria associated with a particular computer-executable task, the server-based application performance monitor may generate one or more dashboard visualizations (e.g., one or more descriptive data visualizations) based on the performance of the server-based application, alert one or more components and/or other entities, and/or the like.

In some embodiments, the server-based application performance monitor may perform a diagnostic operation based on an interface definition data object and/or a server-based application. For example, the server-based application performance monitor may perform a diagnostic operation on an interface definition data object and/or server-based application using defined executable code. In some examples, the defined executable code may be associated with a particular computer-executable task. In some examples, the server-based application performance monitor may generate one or more diagnostic data objects for a respective interface definition data object and/or server-based application in response to a diagnostic operation.

In various embodiments, a diagnostic operation may comprise one or more of the functions described herein associated with the server-based application performance monitor. In various examples, diagnostic operations, defined executable code, and/or defined performance criteria may be used by the server-based application performance monitor to test interface definition data objects and/or server-based applications to meet various standards of performance, benchmarks, and/or other criteria. For example, the server-based application performance monitor may use a diagnostic operation, defined executable code, and/or defined performance criteria to test the structure, requirements, performance, compliance, and/or the like, of an interface definition data object and/or server-based application.

In some embodiments, a diagnostic operation may compile, stress-test, parse, analyze, benchmark, diagnose, and/or the like, an interface definition data object and/or server-based application. In various examples, a diagnostic operation may be associated with defined executable code. For example, defined executable code may simulate and/or replicate the performance of a computer-executable task. In some examples, defined executable code may be associated with a predetermined outcome such that the performance of a server-based application may be tested. For example, a diagnostic operation using defined executable code and a server-based application may test the server-based application with predetermined inputs associated with expected outputs. In some examples, a diagnostic operation associated with defined executable code may provide and/or comprise a test harness for an interface definition data object and/or server-based application.

In certain embodiments, the server-based application performance monitor may test interface definition data objects and/or server-based applications (e.g., by monitoring performance, using comparisons, defined performance criteria, diagnostic operations, defined executable code, etc.) for having minimum standards, being up to date (e.g., based on version identifiers, SLAs, etc.), having minimum required responses for certain computer-executable tasks (e.g., querying a particular target component), and/or the like.

In some embodiments, a diagnostic data object may describe the performance and/or outcome of an interface definition data object and/or server-based application with respect to one or more operations performed by the server-based application performance monitor. For example, a diagnostic data object may describe a diagnostic operation, defined executable code, a computer-executable task, and/or the like. Additionally or alternatively, a diagnostic data object may describe the performance of an interface definition data object and/or server-based application, the outcome of a diagnostic operation, and/or the like. For example, a diagnostic data object may comprise descriptive data such as the time taken to complete particular diagnostic operation, the inputs, outputs, and expected outputs of a diagnostic operation, one or more data visualizations, and/or the like. Additionally or alternatively, a diagnostic data object may approve an interface definition data object and/or server-based application for use. Additionally or alternatively, a diagnostic data object may disapprove an interface definition data object and/or server-based application for use. Additionally or alternatively, a diagnostic data object may provide data indicative of why an interface definition data object and/or server-based application is approved or disapproved for use. Additionally or alternatively, a diagnostic data object may be used to render one or more dashboard visualizations.

The term “manage” with respect to a data object refers to one or more actions performable for altering a data object and/or information therein. Non-limiting examples of actions for managing a data object include deleting a data object, creating a data object, editing a portion of information embodied by and/or otherwise stored in a data object, altering the state of a data object, and/or altering access to a data object.

The term “maintain” with respect to a data object and/or an application refers to a state of read and/or write access to a memory or other storage for persistently and/or temporarily storing the data object by the application. In some such contexts, an application that maintains a data object is permissioned to directly alter information embodied by and/or stored in the data object.

The term “region” represents a physical location which may host resources and components. In some embodiments, a region is mapped to a particular region supported by, for example, AWS or another cloud computing or server system.

The term “interaction signal” refers to a signal received by one or more computing devices (e.g., servers, systems, platforms, etc.) which are configured to cause an application framework system to perform one or more actions associated with one or more components of the application framework system. The interaction signal may be received via a component management interface, an API, a communication interface, the like, or combinations thereof. In one or more embodiments, the interaction signal may be generated by a client device via one or more computer program instructions. In various embodiments, an interaction signal may be generated via a collaborative application, event, event stream, or the like. Additionally or alternatively, the interaction signal may cause one or more actions, one or more changes, and/or one or more predictive inferences with respect to a collaborative application, event, event stream, or the like.

The term “interface element” refers to a rendering of a visualization and/or human interpretation of data associated with an application framework and/or a distributed ledger system. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “graphical control element” refers to a computer input element that allows a user to enter input to facilitate one or more actions with respect to an application framework.

The term “interface area” refers to an area of an electronic interface, where the area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more graphical elements and/or or more textual elements. In certain embodiments, an interface area may be void of an interface element and/or a visualization. In certain embodiments, an interface area may include a graphical control element and/or one or more other interactive interface elements.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

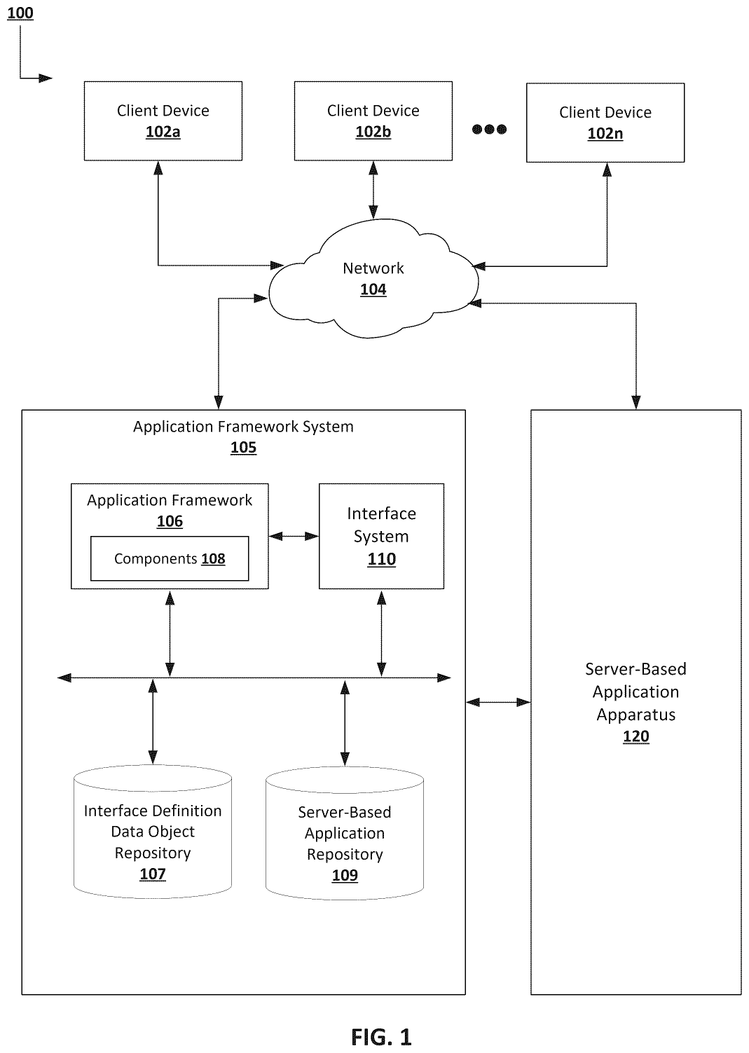

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components may interact with one another in several complex manners to provide collaborative applications and/or collaborative services. In one or more embodiments, the application framework system 105 includes the application framework 106, an interface definition data object repository 107, a server-based application repository 109, and/or an interface system 110. The system architecture 100 also includes a server-based application apparatus 120.

The interface definition data object repository 107 may store one or more interface definition data objects. In some embodiments, the one or more interface definition data objects stored in the interface definition data object repository 107 may include and/or may be stored with data provided by the one or more client devices 102a-n. For example, an interface definition data object stored in the interface definition data object repository 107 may include one or more interface rules provided by the one or more client devices 102a-n. Additionally or alternatively, the one or more interface definition data objects stored in the interface definition data object repository 107 may include and/or may be stored with data that is determined based on one or more components 108 of the application framework 106. The interface definition data object repository 107 may include one or more storage units, such as multiple distributed storage units that are connected through a computer network. Each storage unit in the interface definition data object repository 107 may store one or more interface definition data objects. Moreover, each storage unit in the interface definition data object repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

The server-based application repository 109 may store one or more server-based applications. In some embodiments, the server-based applications stored in the server-based application repository 109 may be configured via the server-based application apparatus 120. For example, the server-based application apparatus 120 may configure a server-based application stored in the server-based application repository 109 based on a particular interface definition data object stored in the interface definition data object repository 107. Additionally or alternatively, the one or more server-based applications stored in the server-based application repository 109 may include and/or may be stored with data that is determined based on one or more components 108 of the application framework 106. The server-based application repository 109 may include one or more storage units, such as multiple distributed storage units that are connected through a computer network. Each storage unit in the server-based application repository 109 may store one or more server-based applications. Moreover, each storage unit in the server-based application repository 109 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

In an embodiment, the server-based application apparatus 120 is implemented separate from the application framework system 105. Alternatively, in certain embodiments, the application framework system 105 may include the server-based application apparatus 120. In various embodiments, the server-based application apparatus 120 may be configured to interact with application framework system 105. For example, in one or more embodiments, the server-based application apparatus 120 may be configured to interact with and/or manage the interface definition data object repository 107, the server-based application repository 109, the interface system 110, and/or one or more components of the application framework 106. In some embodiments, the server-based application apparatus 120 is configured to manage, configure, analyze, and/or update one or more server-based applications stored in server-based application repository 109. In some embodiments, the server-based application apparatus 120 is configured to monitor performance of one or more server-based applications being utilized via the application framework 106. In some embodiments, the server-based application apparatus 120 is configured to manage access to the server-based application repository 109. For example, in some embodiments, the server-based application apparatus 120 is configured to manage authorization of one or more data access requests and/or or more data write requests with respect to the server-based application repository 109. In various embodiments, the application framework system 105 and/or the server-based application apparatus 120 may also be configured to interact with the one or more client devices 102a-n.

The application framework system 105, the server-based application apparatus 120, and/or the one or more client devices 102a-n may be in communication using a network 104. Additionally or alternatively, in various embodiments, the application framework system 105 and the server-based application apparatus 120 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, or another type of computing device. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more interaction signals from one or more of the client devices 102a-n. An interaction signal refers to a signal configured to cause one or more actions with respect to the application framework 106. For example, an interaction signal may be a signal configured to cause one or more actions with respect to one or more computing devices and or one or more components managed by the application framework 106. An interaction signal may be generated by the one or more client devices 102a-n and may be received via a component management interface of the application framework 106, an API of the application framework 106, a communication interface of the application framework 106, the interface system 110, the like, or combinations thereof. Based on the one or more interaction signals, the application framework system 105 may perform one or more actions with respect to the application framework 106. In various embodiments, the one or more actions may be associated with one or more user identifiers associated with one or more events with respect to one or more components of the application framework 106. For example, the one or more actions may initiate and/or correspond to one or more events with respect to one or more components of the application framework 106. In certain embodiments, the one or more actions may be associated with one or more events with respect to a one or more computing devices and or one or more components managed by the application framework 106. In certain embodiments, the one or more actions may be associated with one or more user identifiers with respect to one or more computing devices and or one or more components managed by the application framework 106.

In some embodiments, the server-based application apparatus 120 may manage and/or configure one or more components of the application framework system 105 based on one or more server-based applications stored in the server-based application repository 109. For example, in one or more embodiments, the server-based application apparatus 120 may obtain an interface definition data object from the interface definition data object repository 107. The interface definition data object may include a set of interface rules associated with managing communications between the components 108 of the application framework 106. In one or more embodiments, the server-based application apparatus 120 may determine a particular computer-executable task from a plurality of computable-executable tasks associated with the application framework 106. Additionally, the server-based application apparatus 120 may transform the interface definition data object into a server-based application. The server-based application may be associated with a particular type of programming format from a plurality of programming formats capable of being utilized via the application framework 106. The server-based application apparatus 120 may transform the interface definition data object into the server-based application based on the set of interface rules and/or data associated with the particular computer-executable task. In one or more embodiments, the server-based application apparatus 120 may initiate utilization of the server-based application via the application framework 106. For example, the server-based application apparatus 120 may initiate utilization of the server-based application via the one or more components 108 and/or the one or more client devices 102a-n.

In one or more embodiments, the server-based application apparatus 120 may monitor performance of the server-based application, the one or more components 108, and/or the application framework 106. In some embodiments, the server-based application apparatus 120 may generate a mapping of respective components 108 to the server-based application to facilitate updating, reconfiguring, and/or modifying utilization of the server-based application via the application framework 106 and/or the one or more client devices 102a-n. In one or more embodiments, the server-based application apparatus 120 may determine whether the utilization of the server-based application satisfies defined performance criteria for the server-based application. Additionally, the server-based application apparatus 120 may initiate one or more actions associated with the server-based application based on whether the utilization of the server-based application satisfies the defined performance criteria for the server-based application. The one or more actions may include updating, reconfiguring, and/or modifying utilization of the server-based application via the application framework 106 and/or the one or more client devices 102a-n. The one or more actions may additionally or alternatively include rending a dashboard visualization via an electronic interface of the one or more client devices 102a-n.

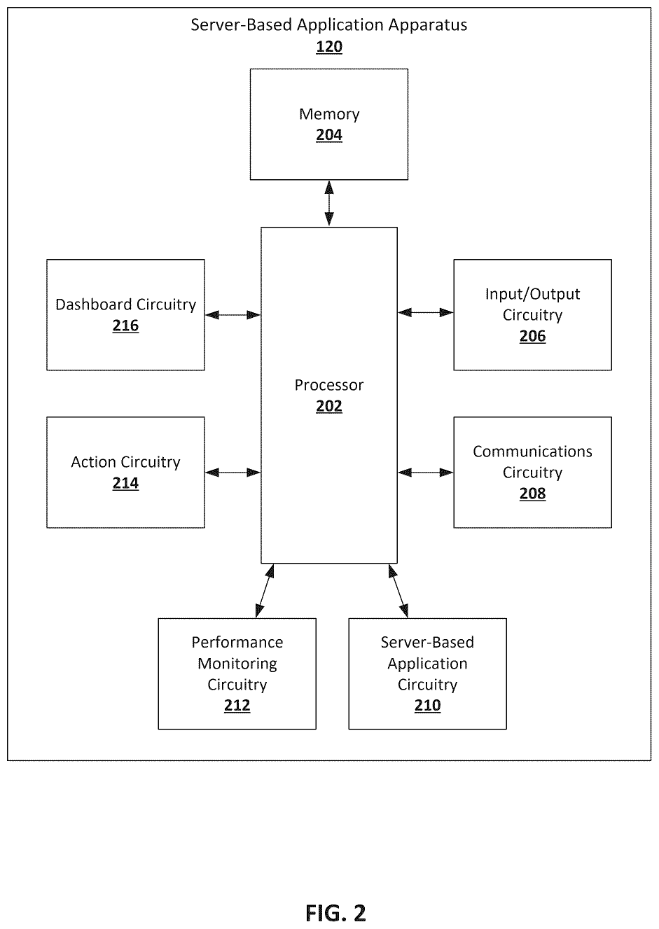

The server-based application apparatus 120 may be embodied by one or more computing systems, such the server-based application apparatus 120 illustrated in FIG. 2. In one or more embodiments, the server-based application apparatus 120 may include processor 202, memory 204, input/output circuitry 206, communications circuitry 208, server-based application circuitry 210, performance monitoring circuitry 212, action circuitry 214, and/or dashboard circuitry 216. The server-based application apparatus 120 may be configured to execute the operations described herein. Although these components 202-216 are described with respect to functional limitations, it should be understood that the particular implementations necessarily include the use of particular hardware. It should also be understood that certain of these components 202-216 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud”processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the techniques and/or operations described herein when the instructions are executed.

In some embodiments, the server-based application apparatus 120 may include input/output circuitry 206 that may, in turn, be in communication with processor 202 to provide output to the user and, in some embodiments, to receive an indication of a user input. In some embodiments, the input/output circuitry 206 may be configured to render a user interface. Additionally or alternatively, the input/output circuitry 206 may be configured to render and/or control a display, and may comprise a web user interface, a mobile application, a query-initiating computing device, a kiosk, or the like. In some embodiments, the input/output circuitry 206 may be communicatively coupled to and/or include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the server-based application apparatus 120. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

In some embodiments, the communications circuitry 208 may act as an intermediary for one or more components of the application framework 106. For example, the communications circuitry 208 may receive and process requests, call, messages, and/or the like for one or more components of the application framework 106. In some embodiments, the communications circuitry 208 may additionally or alternatively support data routing, traffic control, security, decryption, encryption, optimization, and/or the like for data associated with one or more components of application framework 106. For example, the communications circuitry 208 may receive a service message and perform one or more subsequent actions based on the service message. In some embodiments, the communications circuitry 208 may provide functionality of a service proxy for one or more components of the application framework 106. In some embodiments, the communications circuitry 208 may also be configured to generate access logs and/or historical data including information associated with a particular computing device, component, component object, the like, or combinations thereof.

In some embodiments, the communications circuitry 208 may be any means such as a device or circuitry embodied in either hardware or a combination of hardware and software that is configured to interact with the application framework system 105 and/or the one or more client devices 102a-n. In various embodiments, the communications circuitry 208 may monitor, analyze, and/or process data associated with the application framework system 105 such as, for example, data stored in the interface definition data object repository 107 and/or data related to a collaborative application. For example, in various embodiments, the communications circuitry 208 may monitor event streams associated with the application framework 106 to detect respective candidate actions related to components of the application framework 106. In certain embodiments, the communications circuitry 208 may be configured to retrieve metadata associated with the application framework 106 and/or the interface definition data object repository 107 to facilitate detection of respective candidate actions related to components of the application framework 106. The metadata may include, for example, data associated with relationships, sources, targets, ownership, consumption, libraries, activities, attributes, incidents, communication channels, dashboards, data repositories, labels, descriptions, and/or other data related to the application framework 106 and/or the interface definition data object repository 107. In some embodiments, to facilitate monitoring of event streams, the communications circuitry 208 may be configured to ping one or more computing devices of the application framework 106, such as via an internet control message protocol, to receive information related to one or more components of the application framework 106. In some embodiments, to obtain data objects associated with service messages, the communications circuitry 208 may transmit one or more API calls to one or more API servers associated with the noted client devices.

The server-based application circuitry 210 may be any means such as a device or circuitry embodied in either hardware or a combination of hardware and software that is configured to interact with the interface definition data object repository 107 and/or the server-based application repository 109. For example, the server-based application circuitry 210 may be any means such as a device or circuitry embodied in either hardware or a combination of hardware and software that is configured to generate and/or update a server-based application based on an interface definition data object. In some embodiments, the server-based application circuitry 210 may be configured to receive an interface definition data object from the interface definition data object repository 107. The interface definition data object may include a set of interface rules associated with managing communications between the components 108 of the application framework 106. In one or more embodiments, the server-based application circuitry 210 may determine a particular computer-executable task from a plurality of computable-executable tasks associated with the application framework 106. Additionally, the server-based application circuitry 210 may transform the interface definition data object into a server-based application. The server-based application may be associated with a particular type of programming format from a plurality of programming formats capable of being utilized via the application framework 106. The server-based application circuitry 210 may transform the interface definition data object into the server-based application based on the set of interface rules and/or data associated with the particular computer-executable task. In one or more embodiments, the server-based application circuitry 210 may initiate utilization of the server-based application via the application framework 106. For example, the server-based application circuitry 210 may initiate utilization of the server-based application via the one or more components 108 and/or the one or more client devices 102a-n.

The performance monitoring circuitry 212 may be any means such as a device or circuitry embodied in either hardware or a combination of hardware and software that is configured to monitor performance of one or more server-based applications and/or one or more components associated with the application framework 106. In one or more embodiments, the performance monitoring circuitry 212 may be any means such as a device or circuitry embodied in either hardware or a combination of hardware and software that is configured to monitor performance of one or more server-based applications, the one or more components 108, and/or the application framework 106. In some embodiments, the performance monitoring circuitry 212 may generate a mapping of respective components 108 to a server-based application to facilitate updating, reconfiguring, and/or modifying utilization of the server-based application via the application framework 106 and/or the one or more client devices 102a-n. In one or more embodiments, the performance monitoring circuitry 212 may determine whether the utilization of one or more server-based applications satisfies defined performance criteria for the one or more server-based applications.

The action circuitry 214 may be any means such as a device or circuitry embodied in either hardware or a combination of hardware and software that is configured to initiate and/or execute one or more actions with respect to one or more server-based applications, the application framework 106, and/or the one or more client devices 102a-n. In one or more embodiments, the action circuitry 214 may be any means such as a device or circuitry embodied in either hardware or a combination of hardware and software that is configured to initiate one or more actions associated with a server-based application based on whether the utilization of the server-based application satisfies the defined performance criteria for the server-based application. The one or more actions may include updating, reconfiguring, and/or modifying utilization of the server-based application via the application framework 106 and/or the one or more client devices 102a-n. The one or more actions may additionally or alternatively include rending a dashboard visualization via an electronic interface of the one or more client devices 102a-n.

The dashboard circuitry 216 may be any means such as a device or circuitry embodied in either hardware or a combination of hardware and software that is configured to initiate a rendering of a dashboard visualization via an electronic interface. In some embodiments, the dashboard circuitry 216 may initiate a rendering of a dashboard visualization via an electronic interface based on one or more server-based applications and/or one or more utilization metrics associated therewith.

In some embodiments, one or more external systems (such as a remote cloud computing and/or data storage system) may also be leveraged to provide at least some of the functionality discussed herein.

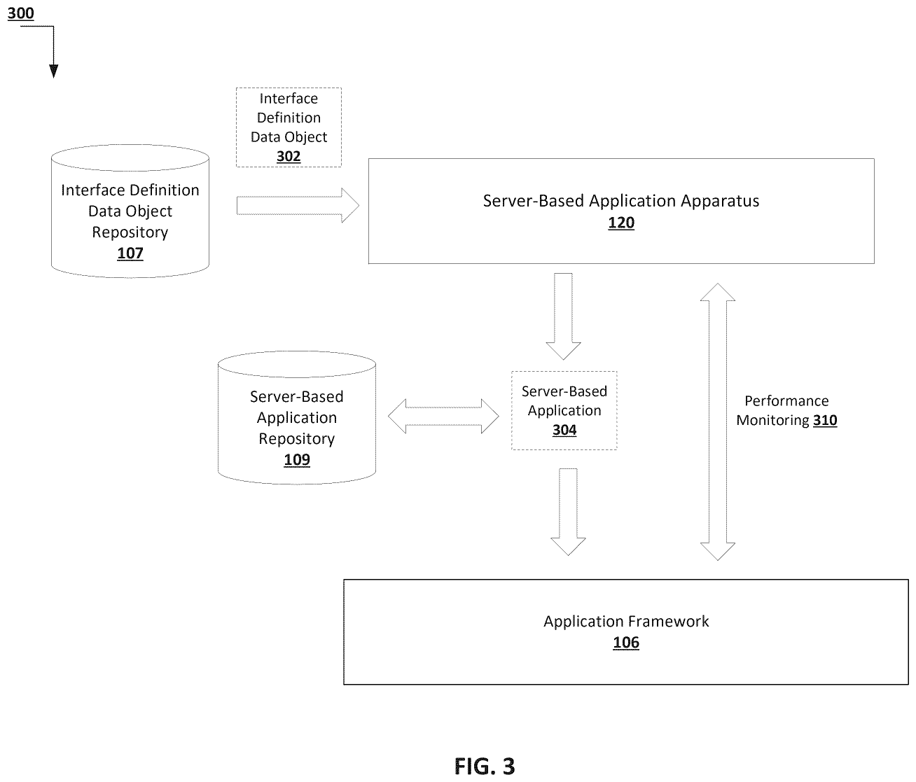

Referring to FIG. 3, an example data flow 300 is presented in accordance with one or more embodiments of the present disclosure. The data flow 300 depicts functionality between various sub-systems of the present disclosure, including the application framework 106, the interface definition data object repository 107, the server-based application repository 109, and/or the server-based application apparatus 120. One or more portions of the data flow 300 may be executed and/or performed by the server-based application apparatus 120. In one or more embodiments, the data flow 300 may be associated with a process executed and/or performed by the server-based application apparatus 120 for transforming an interface definition data object associated with sever interface rules into a server-based application associated with the application framework 106. The data flow 400 may be additionally or alternatively associated with a process executed and/or performed by the server-based application apparatus 120 for monitoring performance of the server-based application associated with particular server interface functionality.

In one or more embodiments, the server-based application apparatus 120 may receive an interface definition data object 302 from the interface definition data object repository 107. The interface definition data object repository 107 may be accessible by the one or more client devices 102a-n communicatively coupled to the application framework 106. The interface definition data object 302 may include a set of interface rules associated with managing communications between the components 108 of the application framework 106. The set of interface rules may be additionally or alternatively associated with managing communications between the one or more client devices 102a-n and the application framework 106. In some embodiments, one or more portions of the set of interface rules may be configured based on user input provided via the one or more client devices 102a-n.

In one or more embodiments, the server-based application apparatus 120 may determine a particular computer-executable task from a plurality of computable-executable tasks associated with the application framework 106. Additionally, the server-based application apparatus 120 may transform the interface definition data object 302 into a server-based application 304. The server-based application 304 may be associated with a particular type of programming format from a plurality of programming formats capable of being utilized by the application framework 106 to execute one or more of the components 108. In some embodiments, the server-based application apparatus 120 may transform the interface definition data object 302 into the server-based application 304 based on the set of interface rules and/or data associated with the particular computer-executable task. In some embodiments, the server-based application apparatus 120 may transform the interface definition data object 302 into the server-based application 304 based on a definition version identifier associated with the interface definition data object 302. In some embodiments, the server-based application apparatus 120 may transform the interface definition data object 302 into the server-based application 304 based on user input data object that defines one or more utilization behaviors associated with the server-based application 304.

In one or more embodiments, the server-based application apparatus 120 may initiate utilization of the server-based application 304 via the application framework 106 and/or the one or more client devices 102a-n. In some embodiments, the server-based application apparatus 120 may execute the particular computer-executable task via the application framework 106 based on the server-based application 304. In some embodiments, the server-based application apparatus 120 may initiate storage of the server-based application 304 via the server-based application repository 109 that is accessible by the one or more client devices 102a-n communicatively coupled to the application framework 106. In some embodiments, the server-based application 304 may be utilized by the one or more client devices 102a-n to enable virtual machine functionality with the application framework 106. In some embodiments, the server-based application apparatus 120 may initiate utilization of the server-based application 304 based on a user input data object that defines one or more utilization behaviors associated with the server-based application 304. For example, the user input data object may initiate a modification of the server-based application 304 based on desirable utilization behaviors associated with API calls, component communications, security rules, and/or other user configurations.

Additionally, in one or more embodiments, the server-based application apparatus 120 may execute performance monitoring 310 associated with the server-based application 304 and/or the application framework 106. For example, the server-based application apparatus 120 may execute the performance monitoring 310 to monitor performance of the application framework 106 and/or the components 108 of the application framework 106 based on the server-based application 304. In some embodiments, the server-based application apparatus 120 may execute the performance monitoring 310 to generate a mapping of respective components 108 of the application framework 106 to the server-based application 304.

In some embodiments, the server-based application apparatus 120 may execute the performance monitoring 310 to determine one or more utilization metrics associated with the utilization of the server-based application 304. Additionally, in some embodiments, the server-based application apparatus 120 may execute the performance monitoring 310 to initiate a rendering of a performance dashboard visualization via an electronic interface based on the one or more utilization metrics. In some embodiments, the server-based application apparatus 120 may determine the one or more utilization metrics based on a definition version identifier associated with the server-based application 304. Additionally or alternatively, the server-based application apparatus 120 may determine the one or more utilization metrics based on the particular computer-executable task. Additionally or alternatively, the server-based application apparatus 120 may determine the one or more utilization metrics based on execution of a computer-executable task associated with one or more components 308 of the application framework 106. In some embodiments, the server-based application apparatus 120 may monitor the performance of the server-based application 304 and/or the application framework 106 based on one or more SLA objectives (e.g., one or more SLA targets) associated with the application framework 106.

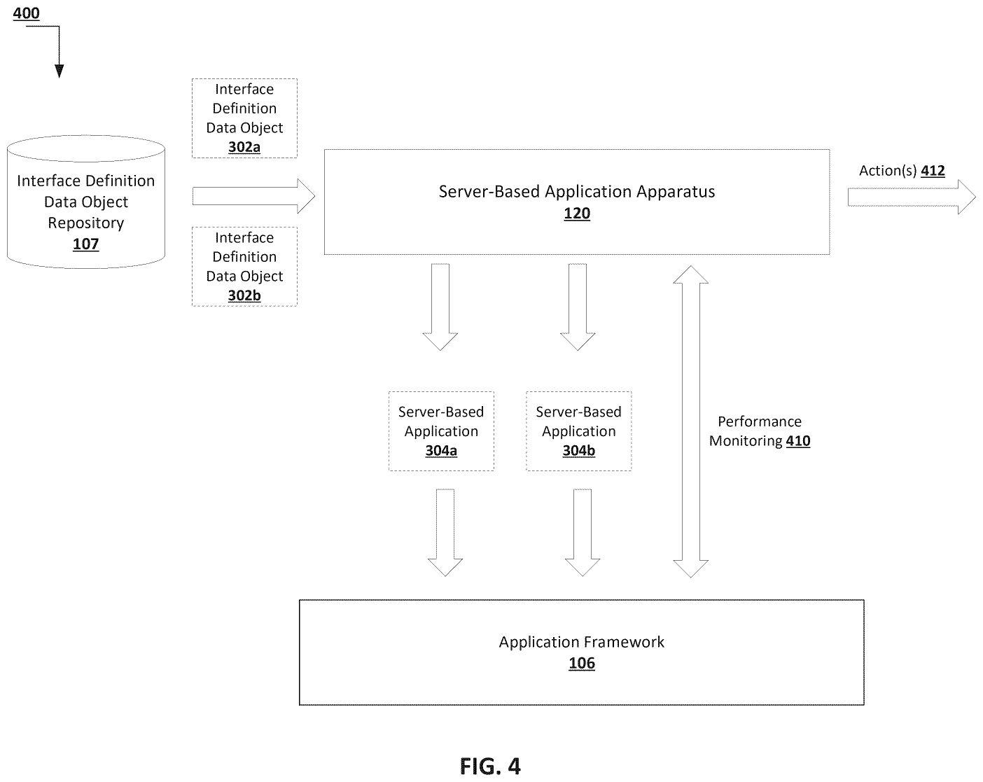

Referring to FIG. 4, an example data flow 400 is presented in accordance with one or more embodiments of the present disclosure. The data flow 400 depicts functionality between various sub-systems of the present disclosure, including the application framework 106, the interface definition data object repository 107, the server-based application repository 109, and/or the server-based application apparatus 120. One or more portions of the data flow 400 may be executed and/or performed by the server-based application apparatus 120. In one or more embodiments, the data flow 400 may be associated with a process executed and/or performed by the server-based application apparatus 120 for transforming two or more interface definition data objects associated with respective sever interface rules into two or more server-based applications associated with the application framework 106. The data flow 400 may be additionally or alternatively associated with a process executed and/or performed by the server-based application apparatus 120 for monitoring performance of the two or more server-based applications associated with respective server interface functionality.

In one or more embodiments, the server-based application apparatus 120 may receive an interface definition data object 302a and an interface definition data object 302b from the interface definition data object repository 107. In some embodiments, the interface definition data object 302a is different than the interface definition data object 302b. In other embodiments, the interface definition data object 302b may correspond to the interface definition data object 302a. The interface definition data object repository 107 may be accessible by the one or more client devices 102a-n communicatively coupled to the application framework 106. The interface definition data object 302a may include a first set of interface rules associated with managing communications between the components 108 of the application framework 106. The first set of interface rules may be additionally or alternatively associated with managing communications between the one or more client devices 102a-n and the application framework 106. Additionally, the interface definition data object 302b may include a second set of interface rules associated with managing communications between the components 108 of the application framework 106. The second set of interface rules may be additionally or alternatively associated with managing communications between the one or more client devices 102a-n and the application framework 106. In some embodiments, one or more portions of the first set of interface rules and/or the second set of interface rules may be configured based on user input provided via the one or more client devices 102a-n.

In one or more embodiments, the server-based application apparatus 120 may determine a particular computer-executable task from a plurality of computable-executable tasks associated with the application framework 106. Additionally, the server-based application apparatus 120 may transform the interface definition data object 302a into a server-based application 304a. The server-based application apparatus 120 may also transform the interface definition data object 302b into a server-based application 304b.

The server-based application 304a may be associated with a first type of programming format from a plurality of programming formats capable of being utilized by the application framework 106 to execute one or more of the components 108. In some embodiments, the server-based application apparatus 120 may transform the interface definition data object 302a into the server-based application 304a based on the first set of interface rules and/or data associated with the particular computer-executable task. In some embodiments, the server-based application apparatus 120 may transform the interface definition data object 302a into the server-based application 304a based on a first definition version identifier associated with the interface definition data object 302a. In some embodiments, the server-based application apparatus 120 may transform the interface definition data object 302a into the server-based application 304a based on user input data object that defines one or more utilization behaviors associated with the server-based application 304a.

The server-based application 304b may be associated with a second type of programming format from a plurality of programming formats capable of being utilized by the application framework 106 to execute one or more of the components 108. In some embodiments, the server-based application apparatus 120 may transform the interface definition data object 302b into the server-based application 304b based on the second set of interface rules and/or data associated with the particular computer-executable task. In some embodiments, the server-based application apparatus 120 may transform the interface definition data object 302b into the server-based application 304b based on a second definition version identifier associated with the interface definition data object 302b. In some embodiments, the server-based application apparatus 120 may alternatively transform the interface definition data object 302b into the server-based application 304b based on the definition version identifier associated with the interface definition data object 302a. In some embodiments, the server-based application apparatus 120 may transform the interface definition data object 302b into the server-based application 304b based on user input data object that defines one or more utilization behaviors associated with the server-based application 304b.

In one or more embodiments, the server-based application apparatus 120 may initiate utilization of the server-based application 304a and the server-based application 304b via the application framework 106 and/or the one or more client devices 102a-n. In some embodiments, the server-based application apparatus 120 may execute the particular computer-executable task via the application framework 106 based on the server-based application 304a and the server-based application 304b. In some embodiments, the server-based application apparatus 120 may initiate storage of the server-based application 304a and the server-based application 304b via the server-based application repository 109 that is accessible by the one or more client devices 102a-n communicatively coupled to the application framework 106. In some embodiments, the server-based application 304a and/or the server-based application 304b may be utilized by the one or more client devices 102a-n to enable virtual machine functionality with the application framework 106.

Additionally, in one or more embodiments, the server-based application apparatus 120 may execute performance monitoring 410 associated with the server-based application 304a, the server-based application 304b, and/or the application framework 106. For example, the server-based application apparatus 120 may execute the performance monitoring 410 to monitor performance of the application framework 106 and/or the components 108 of the application framework 106 based on the server-based application 304a and/or the server-based application 304b. In some embodiments, the server-based application apparatus 120 may execute the performance monitoring 410 to generate a mapping of respective components 108 of the application framework 106 to the server-based application 304a and/or the server-based application 304b.

In some embodiments, the server-based application apparatus 120 may execute the performance monitoring 410 to determine one or more utilization metrics associated with the utilization of the server-based application 304a and/or the server-based application 304b. Additionally, in some embodiments, the server-based application apparatus 120 may execute the performance monitoring 410 to initiate a rendering of a performance dashboard visualization via an electronic interface based on the one or more utilization metrics. In some embodiments, the server-based application apparatus 120 may determine the one or more utilization metrics based on a first definition version identifier associated with the server-based application 304a and a second definition version identifier associated with the server-based application 304b. Additionally or alternatively, the server-based application apparatus 120 may determine the one or more utilization metrics based on the particular computer-executable task. Additionally or alternatively, the server-based application apparatus 120 may determine the one or more utilization metrics based on execution of a computer-executable task associated with one or more components 308 of the application framework 106. In some embodiments, the server-based application apparatus 120 may monitor the performance of the server-based application 304a, the server-based application 304b, and/or the application framework 106 based on one or more SLA objectives associated with the application framework 106.

In one or more embodiments, the server-based application apparatus 120 may execute the performance monitoring 410 to initiate one or more actions 412 associated with the server-based application 304a and/or the server-based application 304b based on whether utilization of the server-based application 304a and/or the server-based application 304b satisfies defined performance criteria. In some embodiments, the server-based application apparatus 120 may execute the performance monitoring 410 to initiate one or more actions 412 associated with the server-based application 304a in response to a determination that the utilization of the server-based application 304a fails to satisfy the defined performance criteria for the server-based application 304b. The one or more actions 412 may include modifying or more portions of the server-based application 304a and/or the server-based application 304b. The one or more actions 412 may additionally or alternatively include restricting utilization of the server-based application 304a and/or the server-based application 304b via the application framework 106 and/or the server-based application repository 109. The one or more actions 412 may additionally or alternatively include initiating a rendering of a visualization (e.g., a dashboard visualization) via an electronic interface based on data associated with the server-based application 304a and/or the server-based application 304b.

In some embodiments, the server-based application apparatus 120 may execute the performance monitoring 410 to modify one or more portions of the server-based application 304a in response to the determination that the utilization of the server-based application 304a fails to satisfy the defined performance criteria for the server-based application 304a. In some embodiments, the server-based application apparatus 120 may additionally or alternatively execute the performance monitoring 410 to modify one or more portions of the interface definition data object 302a in response to the determination that the utilization of the server-based application 304a fails to satisfy the defined performance criteria for the server-based application 304a. In some embodiments, the server-based application apparatus 120 may additionally or alternatively execute the performance monitoring 410 to restrict utilization of the server-based application 304a via the application framework 106 in response to the determination that the utilization of the server-based application 304a fails to satisfy the defined performance criteria for the server-based application 304a.

In some embodiments, the server-based application apparatus 120 may additionally or alternatively execute the performance monitoring 410 to initiate a rendering of a visualization via an electronic interface in response to the determination that the utilization of the server-based application 304a fails to satisfy the defined performance criteria for the server-based application 304a. In some embodiments, in response to a first determination that the utilization of the server-based application 304a satisfies the defined performance criteria for the server-based application 304a and/or a second determination that a particular interval of time is satisfied subsequent to the utilization of the server-based application 304a, the server-based application apparatus 120 may additionally or alternatively execute the performance monitoring 410 to repeatedly determine whether the utilization of the server-based application 304a satisfies the defined performance criteria for the server-based application 304a.

In some embodiments, the server-based application apparatus 120 may additionally or alternatively execute the performance monitoring 410 to modify one or more portions of the server-based application 304b in response to the determination that the utilization of the server-based application 304b fails to satisfy the defined performance criteria for the server-based application 304b. In some embodiments, the server-based application apparatus 120 may additionally or alternatively execute the performance monitoring 410 to modify one or more portions of the interface definition data object 302b in response to the determination that the utilization of the server-based application 304b fails to satisfy the defined performance criteria for the server-based application 304b. In some embodiments, the server-based application apparatus 120 may additionally or alternatively execute the performance monitoring 410 to restrict utilization of the server-based application 304b via the application framework 106 in response to the determination that the utilization of the server-based application 304b fails to satisfy the defined performance criteria for the server-based application 304b.

In some embodiments, the server-based application apparatus 120 may additionally or alternatively execute the performance monitoring 410 to initiate a rendering of a visualization via an electronic interface in response to the determination that the utilization of the server-based application 304b fails to satisfy the defined performance criteria for the server-based application 304b. In some embodiments, in response to a first determination that the utilization of the server-based application 304b satisfies the defined performance criteria for the server-based application 304b and/or a second determination that a particular interval of time is satisfied subsequent to the utilization of the server-based application 304b, the server-based application apparatus 120 may additionally or alternatively execute the performance monitoring 410 to repeatedly determine whether the utilization of the server-based application 304b satisfies the defined performance criteria for the server-based application 304b.

In some embodiments, the server-based application apparatus 120 may additionally or alternatively execute the performance monitoring 410 to compare a first performance of the server-based application 304a and a second performance of the server-based application 304b. In some embodiments, in response to a determination that the first performance of the server-based application 304a is optimal as compared to second performance of the server-based application 304b, the server-based application apparatus 120 may additionally or alternatively execute the performance monitoring 410 to restrict utilization of the server-based application 304b via the application framework 106. In some embodiments, in response to a determination that the second performance of the server-based application 304b is optimal as compared to first performance of the server-based application 304a, the server-based application apparatus 120 may additionally or alternatively execute the performance monitoring 410 to restrict utilization of the server-based application 304a via the application framework 106. In some embodiments, the server-based application apparatus 120 may execute the one or more actions 412 to initiate a rendering of a dashboard visualization via an electronic interface based at least in part on first data associated with the server-based application 304a and second data associated with the server-based application 304b.

In some embodiments, the server-based application apparatus 120 may determine a particular computer-executable task from a plurality of computable-executable tasks associated with the application framework 106. Additionally, the server-based application apparatus 120 may initiate the utilization of the server-based application 304a and/or the server-based application 304b via the application framework 106 based on the particular computer-executable task. The server-based application apparatus 120 may also determine whether the utilization of the server-based application 304a and/or the server-based application 304b satisfies the defined performance criteria based at least in part on the particular computer-executable task.

In some embodiments, the server-based application apparatus 120 may initiate a diagnostic operation for the server-based application 304a based on the interface definition data object 302a and a defined executable code associated with a particular computer-executable task. Additionally, in response to a determination that the diagnostic operation satisfies diagnostic criteria for the interface definition data object 302a, the server-based application apparatus 120 may generate a diagnostic data object for the interface definition data object 302a based on the diagnostic operation.

In some embodiments, the server-based application apparatus 120 may additionally or alternatively initiate a diagnostic operation for the server-based application 304b based on the interface definition data object 302b and a defined executable code associated with a particular computer-executable task. Additionally, in response to a determination that the diagnostic operation satisfies diagnostic criteria for the interface definition data object 302b, the server-based application apparatus 120 may generate a diagnostic data object for the interface definition data object 302b based on the diagnostic operation.

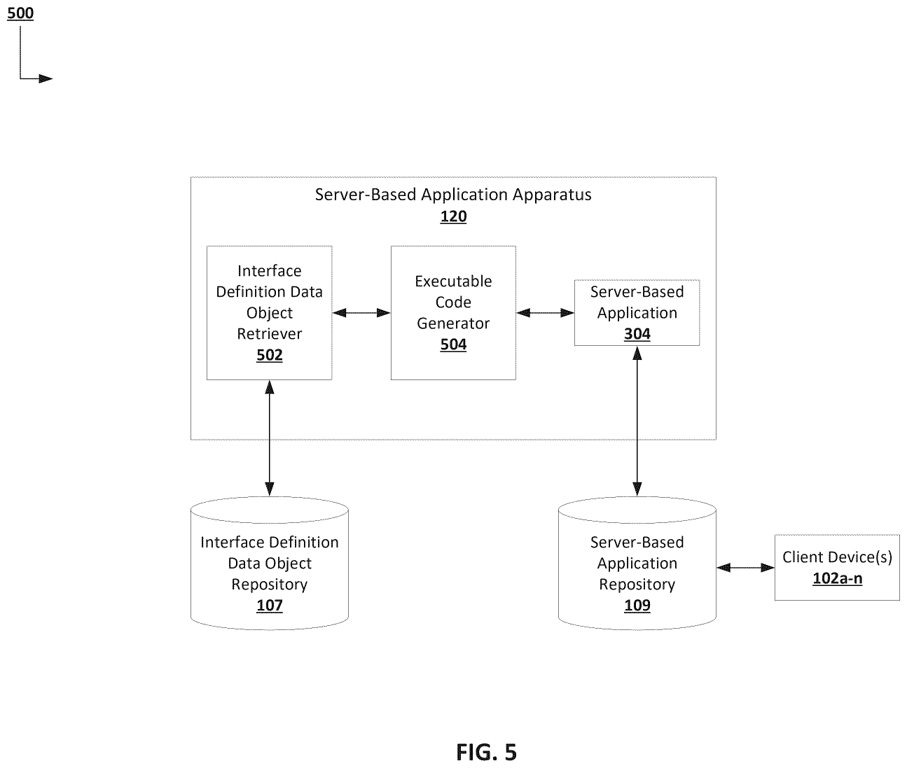

Referring now to FIG. 5, an example application framework system 500 is presented in accordance with one or more embodiments of the present disclosure. As shown, the application framework system 500 includes the server-based application apparatus 120, the interface definition data object repository 107, the server-based application repository 109, and one or more client devices 102a-n. The server-based application apparatus 120 further includes the interface definition data object retriever 502, the executable code generator 504, and the server-based application 304. In some embodiments, the server-based application apparatus 120 may include other otherwise be associated with the interface definition data object retriever 502 and/or the executable code generator 504.

In some embodiments, the interface definition data object retriever 502 may be configured to access the interface definition data object repository 107. For example, the server-based application apparatus 120 may retrieve interface definition data objects from the interface definition data object repository 107 using the interface definition data object retriever 502. In some embodiments, the server-based application apparatus 120 may access the interface definition data object repository 107 via the input/output circuitry 206. Interface definition data object retriever 502 may access the interface definition data object repository 107 continuously (e.g., on a defined schedule) and/or in response to input from a user (e.g., via a client device 102). The interface definition data object retriever 502 may provide retrieved interface definition data objects to the executable code generator 504 to transform the interface definition data objects into server-based applications (e.g., server-based application 304). Although not depicted as such, in various embodiments, the interface definition data object retriever 502 may be an external component to the server-based application apparatus 120. For example, the interface definition data object retriever 502 may be a stand-alone component or a component integrated within another system that is external to and communicatively coupled with the server-based application apparatus 120.

In various embodiments, the server-based application apparatus 120 may be configured to receive interface definition data objects and transform the interface definition data objects into one or more server-based applications. For example, the server-based application apparatus 120 may receive interface definition data objects using the interface definition data object retriever 502 and transform the interface definition data objects into the server-based application 304 using the executable code generator 504. In some embodiments, the executable code generator 504 may generate server-based applications via the server-based application circuitry 210.

In certain embodiments, the server-based application apparatus 120 may make the server-based application 304 accessible to the client devices 102a-n. For example, the server-based application apparatus 120 may provide the server-based application 304 to the server-based application repository 109 where the server-based application 304 may be accessible to the client devices 102a-n. In some embodiments, the server-based application apparatus 120 may provide the server-based application 304 to the server-based application repository 109 via the communications circuitry 208.

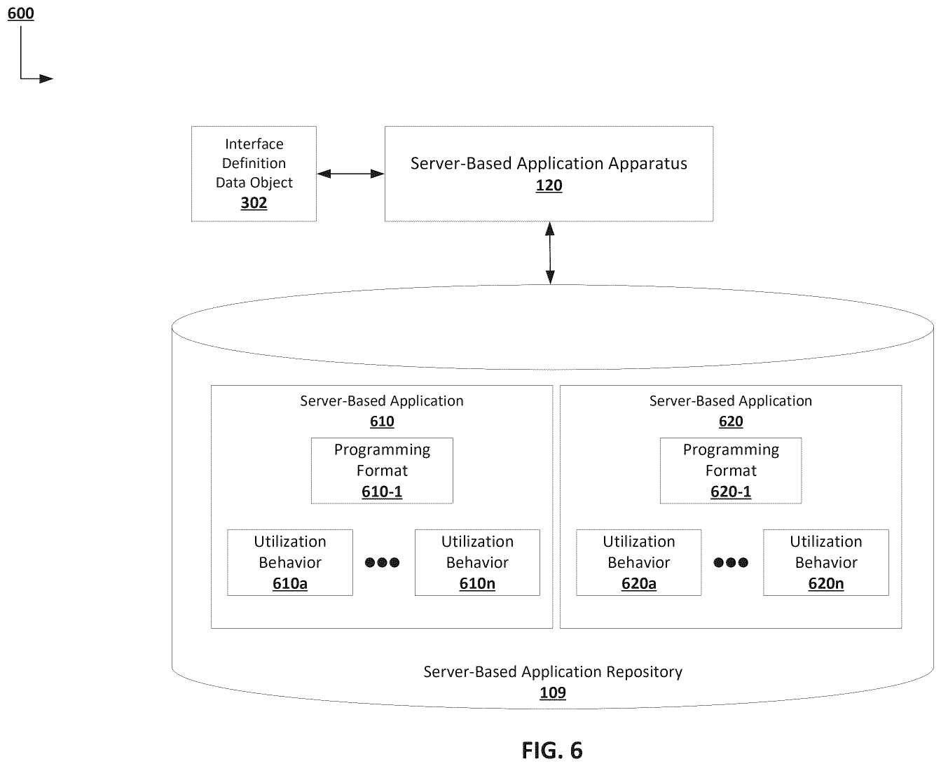

Referring now to FIG. 6, example application framework system 600 is presented in accordance with one or more embodiments of the present disclosure. As shown, the application framework system 600 includes the interface definition data object 302, the server-based application apparatus 120, and the server-based application repository 109. The server-based application repository 109 further includes a server-based application 610 and a server-based application 620. The server-based application 610 includes a programming format 610-1 and utilization behaviors 610a-n. The server-based application 620 includes a programming format 620-1 and utilization behaviors 620a-n.

In various embodiments, the server-based application apparatus 120 may be configured to transform interface definition data objects into one or more server-based applications. For example, the server-based application apparatus 120 may transform the interface definition data object 302 into the server-based application 610. Additionally, the server-based application apparatus 120 may transform the interface definition data object 302 into the server-based application 620. In some embodiments, the server-based application apparatus 120 may transform an interface definition data object into a server-based application associated with a particular type of programming format. For example, the server-based application apparatus 120 may transform the interface definition data object 302 into the server-based application 610 associated with the programming format 610-1 and additionally transform the interface definition data object 302 into the server-based application 620 associated with the programming format 620-1. In various embodiments, the programming formats associated with different server-based applications may be different programming formats. For example, the programming format 610-1 may be one programming format (e.g., JavaScript) while the programming format 620-1 may be a different programming format (e.g., Python).

In some embodiments, the server-based application apparatus 120 may transform an interface definition data object into a server-based application based on a set of interface rules. For example, the interface definition data object 302 may comprise one or more interface rules used by the server-based application apparatus 120 to generate the server-based application 610 and the server-based application 620. In some examples, interface rules of the interface definition data object 302 may be transformed differently by the server-based application apparatus 120 based on the programming format associated with a server-based application. For example, the same interface rules included within the interface definition data object 302 may be transformed differently to generate the server-based application 610 based on the programming format 610-1 compared to how the interface rules are transformed to generate the server-based application 620 based on the programming format 620-1. Additionally or alternatively, in some embodiments, the server-based application apparatus 120 may transform an interface definition data object into a server-based application based on data associate with a computer-executable task. For example, various server-based applications may be generated for performing various computer-executable tasks associated with an application framework.

In certain embodiments, the performance of a server-based application may be modified via one or more utilization behaviors. For example, the server-based application 610 may be configured using the one or more utilization behaviors 610a-n. Similarly, the server-based application 620 may be configured using the one or more utilization behaviors 620a-n. In some embodiments, utilization behaviors may be modified based on received user input. For example, a user input data object (e.g., received via a client device 102) may include one or more settings, parameters, values, and/or the like, used to modify the utilization behaviors 610a-n for the server-based application 610. In some embodiments, a server-based application may be utilized based on user input defining one or more utilization behaviors associated with the server-based application. For example, one or more of the utilization behaviors 610a-n may be configured according to a user input data object when the server-based application is used. In various embodiments, an interface definition data object may be transformed into a server-based application based on user input defining one or more utilization behaviors associated with the server-based application. For example, a user input data object defining one or more utilization behaviors 610a-n may be used to modify the interface definition data object 302 such that the server-based application apparatus 120 generates the server-based application 610 using the utilization behaviors 610a-n defined by the user input data object.

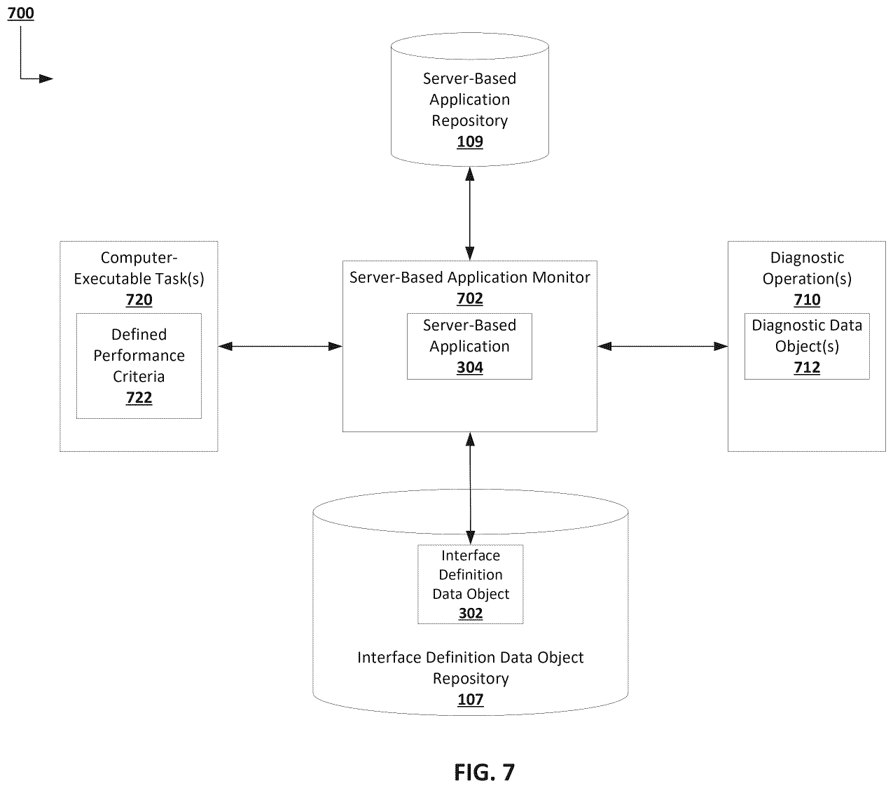

Referring now to FIG. 7, example application framework system 700 is presented in accordance with one or more embodiments of the present disclosure. As shown, the application framework system 700 includes the server-based application monitor 702 which may perform one or more operations associated with the server-based application 304, the server-based application repository 109, and the interface definition data object repository 107 which may include the interface definition data object 302. The server-based application monitor 702 may perform a diagnostic operation 710 associated with diagnostic data object 712 and a computer-executable task 720 associated with defined performance criteria 722.

In various embodiments, the server-based application monitor 702 may be included within and/or otherwise associated with the server-based application apparatus 120. In certain embodiments, the server-based application apparatus 120 may perform one or more operations associated with the server-based application monitor 702 via the performance monitoring circuitry 212. In some embodiments, the server-based application monitor 702 may be configured to access the interface definition data object repository 107. For example, the server-based application monitor 702 may access the interface definition data object repository 107 to retrieve interface definition data objects continuously, periodically (e.g., on a determined schedule), in response to user input, and/or the like. For example, the server-based application monitor 702 may access the interface definition data object 302 stored within the interface definition data object repository 107.

In various embodiments, the server-based application monitor 702 may be configured to perform one or more operations on the interface definition data object 302 and/or the server-based application 304. For example, the server-based application monitor 702 may begin by retrieving the interface definition data object 302 from the interface definition data object repository 107. In various embodiments, the server-based application monitor 702 may analyze and/or test the interface definition data object 302. For example, the server-based application monitor 702 may attempt to transform the interface definition data object 302 into the server-based application 304, process the interface definition data object 302 in the diagnostic operation 710 and/or the like.

In some embodiments, the server-based application monitor 702 may perform one or more actions in response to failing to transform the interface definition data object 302 into the server-based application 304. For example, if the server-based application monitor 702 fails to transform the interface definition data object 302 into the server-based application 304, it may indicate an error associated with the interface definition data object 302. Accordingly, the server-based application monitor 702 may generate one or more alerts, modify one or more portions of the interface definition data object 302, restrict the use of the interface definition data object 302 within the interface definition data object repository 107, flag the interface definition data object 302 for review, remove the interface definition data object 302 from the interface definition data object repository 107, generate a dashboard visualization descriptive of one or more detected errors associated with the interface definition data object 302, and/or the like. In some embodiments, the server-based application monitor 702 may perform one or more diagnostic operations 710 on the interface definition data object 302 to generate one or more diagnostic data objects 712.

In some embodiments, the server-based application monitor 702 may perform one or more actions in response to successfully transforming the interface definition data object 302 into the server-based application 304. For example, the server-based application monitor 702 may then analyze and/or test the server-based application 304. In various embodiments, the server-based application monitor 702 may perform one or more diagnostic operations 710 on the server-based application to generate one or more diagnostic data objects 712. For example, one or more diagnostic operations 710 may identify one or more issues, errors, risks, and/or the like associated with the server-based application 304 and as such, one or more diagnostic data objects 712 descriptive thereof may be generated. Additionally or alternatively, the server-based application monitor 702 may perform one or more computer executable tasks 720 using the server-based application 304 and monitor the performance of the server-based application 304 to be compared against the defined performance criteria 722. For example, if the server-based application 304 fails to perform the computer executable task 720 in a manner that satisfies the defined performance criteria 722, the server-based application monitor 702 may generate one or more alerts, block the server-based application 304 from being provided to the server-based application repository 109, modify one or more portions of the server-based application 304, modify one or more portions of the interface definition data object 302, restrict the use of the interface definition data object 302 within the interface definition data object repository 107, flag the server-based application 304 for review, remove the interface definition data object 302 from the interface definition data object repository 107, flag the interface definition data object 302 for review, generate a dashboard visualization descriptive of one or more detected errors associated with the server-based application 304, generate a dashboard visualization descriptive of one or more detected errors associated with the interface definition data object 302, and/or the like.

In certain embodiments, the server-based application monitor 702, may perform one or more actions in response to the server-based application 304 satisfying the defined performance criteria 722 associated with the computer-executable task 720. For example, the server-based application may repeatedly determine (e.g., on a defined schedule) whether the server-based application 304 satisfies the defined performance criteria 722, provide the server-based application 304 to the server-based application repository 109 such that the server-based application 304 may be accessible to users, and/or the like.

In various embodiments, the server-based application monitor 702 may test and/or process interface definition data objects 302 and/or server-based applications 304 that have already been successfully tested. For example, the interface definition data object 302 may be successfully tested and transformed into the server-based application 304, which may also be successfully tested and provided to the server-based application repository 109 such that the server-based application 304 is being actively used within the application framework 106. In such an example, the server-based application monitor 702 may still continue to test the same interface definition data object 302 and server-based application 304. For example, new computer-executable tasks 720, new defined performance criteria 722, and/or new diagnostic operations 710 may be generated and/or used which may cause the interface definition data object 302 and/or server-based application 304 to fail one or more tests and/or processes associated with the server-based application monitor 702 at a later instance regardless of having succeeded previously. Additionally, new updates to interface definition data objects 302 and/or other components of the application framework 106 may cause downstream implications that may cause the interface definition data object 302 and/or server-based application 304 to fail one or more tests and/or processes associated with the server-based application monitor 702 at a later instance regardless of having succeeded previously. In such cases, it is important that the server-based application monitor 702 continuously test and/or process interface definition data objects and/or server-based applications.

In various embodiments, if the server-based application monitor 702 identifies a failure of a particular server-based application that is already being utilized within the application framework 106 and/or an interface definition data object associated with a particular server-based application that is already being utilized within the application framework 106, the server-based application monitor 702 may be configured to restrict the use of the particular server-based application, generate alerts to one or more entities associated with the particular server-based application, remove the particular server-based application from the server-based application repository 109, identify one or more workflows associated with the particular server-based application, and/or the like.

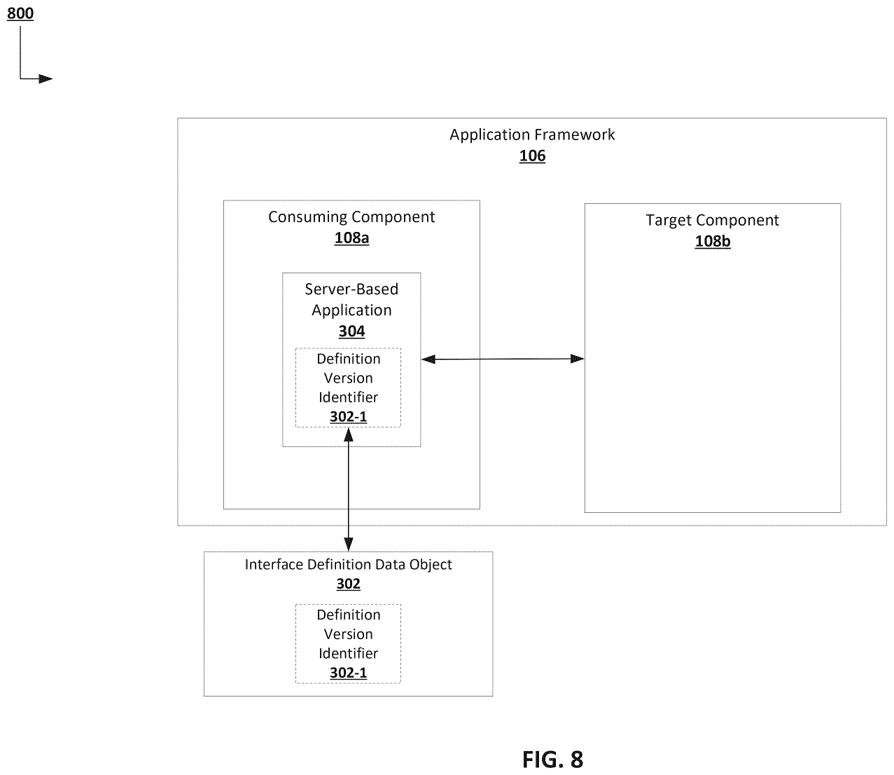

Referring now to FIG. 8, example application framework system 800 is presented in accordance with one or more embodiments of the present disclosure. As shown, the application framework system 800 includes the application framework 106 which includes the consuming component 108a and the target component 108b. The consuming component 108a may utilize the server-based application 304 which may be generated from the interface definition data object 302.

In various embodiments, an interface definition data object may include and/or otherwise be associated with a definition version identifier. For example, the interface definition data object 302 may include the definition version identifier 302-1 indicative of the particular configuration of the interface definition data object 302. Additionally, in some embodiments, server-based applications may include and/or otherwise be associated with definition version identifiers of the interface definition data objects they implement. For example, the server-based application 304 may include the definition version identifier 302-1 because the server-based application 304 was transformed based on the interface definition data object 302.

In various embodiments, various utilization metrics of the application framework 106 may be determined based on definition version identifiers. For example, one or more computer-executable tasks performed by the server-based application 304 for interacting with the target component 108b may be recorded. In a non-limiting example, the consuming component 108a may utilize the server-based application 304 to initiate an API call to the target component 108b. Various data associated with the API call made utilizing the server-based application 304 may be recorded (e.g., utilization metrics, metadata, etc.). For example, the recorded data may indicate that the API call originated at the consuming component 108a and was made to the target component 108b. Additionally or alternatively, the recorded data may indicate that the API call was generated by the particular server-based application 304 as well as additional data describing the server-based application (e.g., an identifier of the server-based application, a type of the server-based application, etc.). Additionally or alternatively, the recorded data may include the definition version identifier 302-1 and indicate that the particular server-based application 304 was transformed based on the particular interface definition data object 302. In this manner, various embodiments described herein may monitor the performance of a multi-component system (e.g., the application framework 106) based at least in part on various utilization metrics and/or definition version identifiers.

In some embodiments, the performance of a multi-component system may be monitored based on one or more SLAs. In a non-limiting contextual example, the interface definition data object may be updated to a new version to comply with an SLA (e.g., by providing a new functionality, security measure, performance level, etc.). Accordingly, users (e.g., developers) may be required to update the use of server-based applications to be based on the latest version of the updated interface definition data object. In such an example, the adoption rate and/or utilization of server-based applications based on the latest version of the updated interface definition data object may be monitored using the functionalities described above with respect to the definition version identifier.

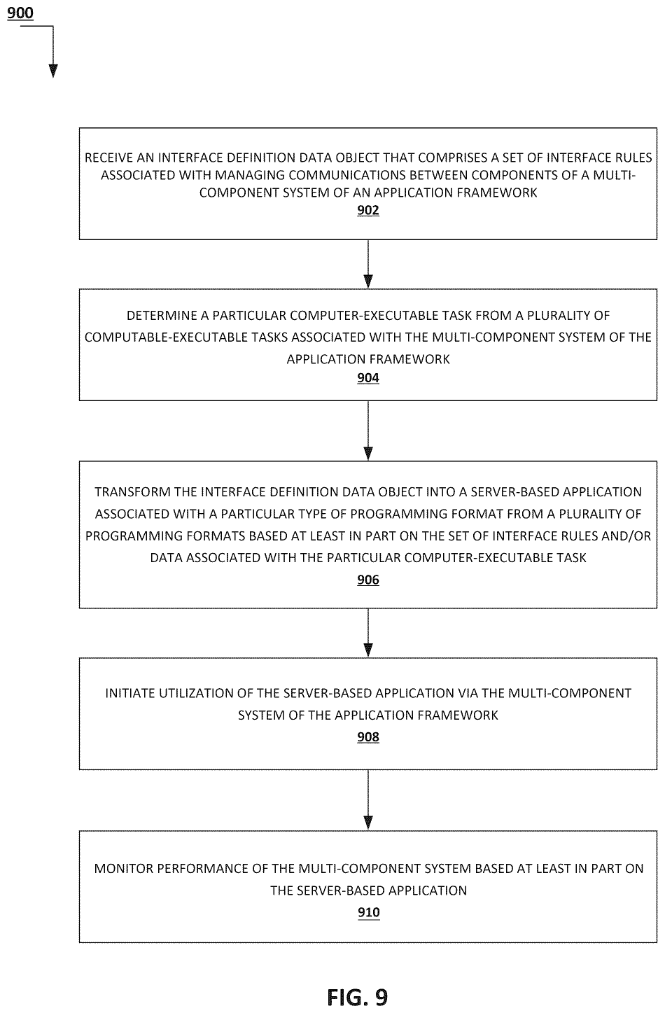

FIG. 9 is a flowchart diagram of an example process 900 for transforming an interface definition data object associated with server interface rules into a server-based application, in accordance with, for example, the server-based application apparatus 120. Via the various operations of process 900, the server-based application apparatus 120 may enhance efficiency, reliability, effectiveness, and/or quality of data of the application framework 106 and/or one or more server-based applications associated with the server-based application repository 109. Via the various operations of process 900, the server-based application apparatus 120 may additionally or alternatively increase storage capacity of the server-based application repository 109 and/or improve load balancing for the application framework 106.

The process 900 begins at operation 902 where an interface definition data object that comprises a set of interface rules associated with managing communications between components of a multi-component system of an application framework is received. The process 900 additionally or alternatively includes an operation 904 that determines a particular computer-executable task from a plurality of computable-executable tasks associated with the multi-component system of the application framework. The process 900 additionally or alternatively includes an operation 906 that transforms the interface definition data object into a server-based application associated with a particular type of programming format from a plurality of programming formats based at least in part on the set of interface rules and/or data associated with the particular computer-executable task. The process 900 additionally or alternatively includes an operation 908 that initiates utilization of the server-based application via the multi-component system of the application framework. The process 900 additionally or alternatively includes an operation 910 that monitors performance of the multi-component system based at least in part on the server-based application. In one or more embodiments, the process 900 includes an operation to monitor performance of the multi-component system based at least in part on the server-based application to generate a mapping of respective components of the multi-component system to the server-based application.

In one or more embodiments, the process 900 additionally or alternatively includes an operation to determine one or more utilization metrics associated with the utilization of the server-based application. In one or more embodiments, the process 900 additionally or alternatively includes an operation to initiate a rendering of a performance dashboard visualization via an electronic interface based at least in part on the one or more utilization metrics.

In one or more embodiments, the process 900 additionally or alternatively includes an operation to determine the one or more utilization metrics based at least in part on a definition version identifier associated with the server-based application.

In one or more embodiments, the process 900 additionally or alternatively includes an operation to determine the one or more utilization metrics based at least in part on the particular computer-executable task.

In one or more embodiments, the process 900 additionally or alternatively includes an operation to determine the one or more utilization metrics based at least in part on execution of a computer-executable task associated with one or more components of the multi-component system.

In one or more embodiments, the process 900 additionally or alternatively includes an operation to transform the interface definition data object into the server-based application based at least in part on a definition version identifier associated with the interface definition data object.

In one or more embodiments, the process 900 additionally or alternatively includes an operation to monitor the performance of the multi-component system based at least in part on one or more SLA objectives associated with the application framework.

In one or more embodiments, the process 900 additionally or alternatively includes an operation to initiate the utilization of the server-based application based at least in part on a user input data object that defines one or more utilization behaviors associated with the server-based application.

In one or more embodiments, the process 900 additionally or alternatively includes an operation to execute the particular computer-executable task based at least in part on the server-based application.

In one or more embodiments, the process 900 additionally or alternatively includes an operation to initiate storage of the server-based application via a data repository that is accessible by one or more client devices communicatively coupled to the application framework.

In one or more embodiments, the process 900 additionally or alternatively includes an operation to retrieve the interface definition data object from a data repository that is accessible by one or more client devices communicatively coupled to the application framework.

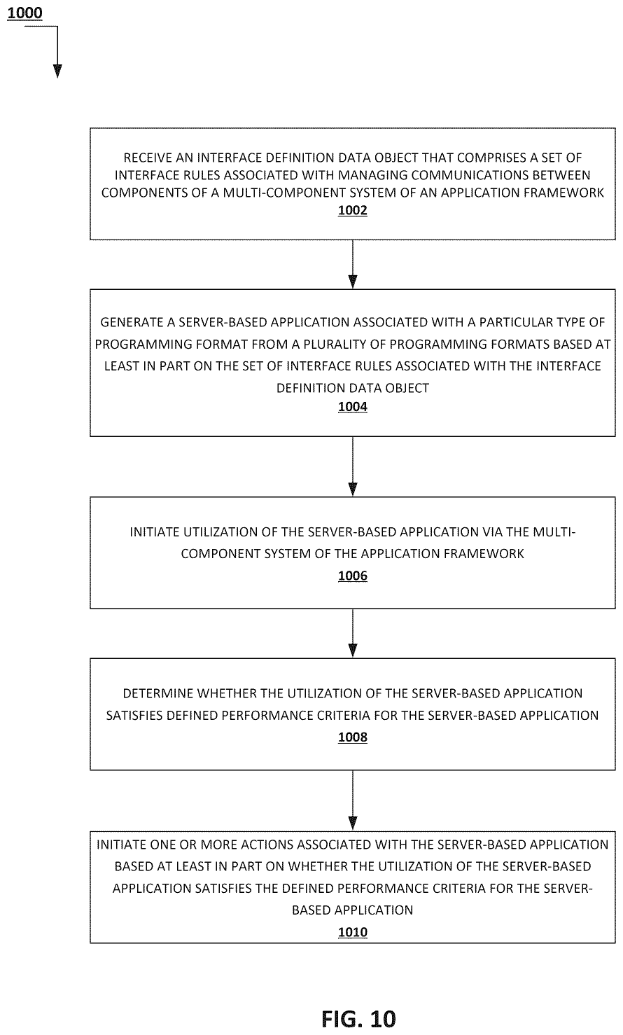

FIG. 10 is a flowchart diagram of an example process 1000 for monitoring performance of a server-based application associated with server interface functionality, in accordance with, for example, the server-based application apparatus 120. Via the various operations of process 1000, the server-based application apparatus 120 may enhance efficiency, reliability, effectiveness, and/or quality of data of the application framework 106 and/or one or more server-based applications associated with the server-based application repository 109. Via the various operations of process 1000, the server-based application apparatus 120 may additionally or alternatively increase storage capacity of the server-based application repository 109 and/or improve load balancing for the application framework 106.

The process 1000 begins at operation 1002 where an interface definition data object that comprises a set of interface rules associated with managing communications between components of a multi-component system of an application framework is received. The process 1000 additionally or alternatively includes an operation 1004 that generates a server-based application associated with a particular type of programming format from a plurality of programming formats based at least in part on the set of interface rules associated with the interface definition data object. The process 1000 additionally or alternatively includes an operation 1006 that initiates utilization of the server-based application via the multi-component system of the application framework. The process 1000 additionally or alternatively includes an operation 1008 that determines whether the utilization of the server-based application satisfies defined performance criteria for the server-based application. The process 1000 additionally or alternatively includes an operation 1010 that initiates one or more actions associated with the server-based application based at least in part on whether the utilization of the server-based application satisfies the performance criteria for the server-based application.

In one or more embodiments, the process 1000 includes an operation to, in response to a determination that the utilization of the server-based application fails to satisfy the defined performance criteria for the server-based application, initiate one or more actions associated with the server-based application.

In one or more embodiments, the process 1000 additionally or alternatively includes an operation to modify one or more portions of the server-based application in response to the determination that the utilization of the server-based application fails to satisfy the defined performance criteria for the server-based application.

In one or more embodiments, the process 1000 additionally or alternatively includes an operation to modify one or more portions of the interface definition data object in response to the determination that the utilization of the server-based application fails to satisfy the defined performance criteria for the server-based application.

In one or more embodiments, the process 1000 additionally or alternatively includes an operation to restrict utilization of the server-based application in response to the determination that the utilization of the server-based application fails to satisfy the defined performance criteria for the server-based application.

In one or more embodiments, the process 1000 additionally or alternatively includes an operation to initiate a rendering of a visualization via an electronic interface in response to the determination that the utilization of the server-based application fails to satisfy the defined performance criteria for the server-based application.

In one or more embodiments, the process 1000 additionally or alternatively includes an operation to, in response to (i) a first determination that the utilization of the server-based application satisfies the defined performance criteria for the server-based application and (ii) a second determination that a particular interval of time is satisfied subsequent to the utilization of the server-based application, repeatedly determine whether the utilization of the server-based application satisfies the defined performance criteria for the server-based application.

In one or more embodiments, the server-based application is a first server-based application and/or the set of interface rules is a first set of interface rules. In one or more embodiments, the process 1000 additionally or alternatively includes an operation to transform the interface definition data object into a second server-based application associated with a second set of interface rules. In one or more embodiments, the process 1000 additionally or alternatively includes an operation to monitor performance of the multi-component system based at least in part on the first server-based application and the second server-based application.

In one or more embodiments, the process 1000 additionally or alternatively includes an operation to compare a first performance of the first server-based application and a second performance of the second server-based application.

In one or more embodiments, the process 1000 additionally or alternatively includes an operation to, in response to a determination that the first performance of the first server-based application is optimal as compared to second performance of the second server-based application, restrict utilization of the second server-based application via the multi-component system of the application framework.

In one or more embodiments, the process 1000 additionally or alternatively includes an operation to initiate a rendering of a dashboard visualization via an electronic interface based at least in part on first data associated with the first server-based application and second data associated with the second server-based application.

In one or more embodiments, the process 1000 additionally or alternatively includes an operation to determine a particular computer-executable task from a plurality of computable-executable tasks associated with the multi-component system of the application framework. In one or more embodiments, the process 1000 additionally or alternatively includes an operation to initiate the utilization of the server-based application via the multi-component system based at least in part on the particular computer-executable task. In one or more embodiments, the process 1000 additionally or alternatively includes an operation to determine whether the utilization of the server-based application satisfies the defined performance criteria based at least in part on the particular computer-executable task.

In one or more embodiments, the process 1000 additionally or alternatively includes an operation to initiate a diagnostic operation based at least in part on (i) the interface definition data object and (ii) a defined executable code associated with a particular computer-executable task. In one or more embodiments, the process 1000 additionally or alternatively includes an operation to, in response to a determination that the diagnostic operation satisfies diagnostic criteria for the interface definition data object, generate a diagnostic data object for the interface definition data object based at least in part on the diagnostic operation.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (Application Specific Integrated Circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web components, web services, web microservices, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's query-initiating computing device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a query-initiating computing device having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) may be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising one or more processors and one or more storage devices storing instructions that are operable, when executed by the one or more processors, to cause the one or more processors to:
receive an interface definition data object that comprises a set of interface rules associated with managing communications between components of a multi-component system of an application framework;
determine a particular computer-executable task from a plurality of computable-executable tasks associated with the multi-component system of the application framework;
transform the interface definition data object into a server-based application associated with a particular type of programming format from a plurality of programming formats based at least in part on (i) the set of interface rules and (ii) data associated with the particular computer-executable task;
initiate utilization of the server-based application via the multi-component system of the application framework; and
monitor performance of the multi-component system based at least in part on the server-based application to generate a mapping of respective components of the multi-component system to the server-based application.

2. The apparatus of claim 1, wherein the instructions are further operable, when executed by the one or more processors, to cause the one or more processors to:
determine one or more utilization metrics associated with the utilization of the server-based application; and
initiate a rendering of a performance dashboard visualization via an electronic interface based at least in part on the one or more utilization metrics.

3. The apparatus of claim 2, wherein the instructions are further operable, when executed by the one or more processors, to cause the one or more processors to:
determine the one or more utilization metrics based at least in part on a definition version identifier associated with the server-based application.

4. The apparatus of claim 2, wherein the instructions are further operable, when executed by the one or more processors, to cause the one or more processors to:
determine the one or more utilization metrics based at least in part on the particular computer-executable task.

5. The apparatus of claim 2, wherein the instructions are further operable, when executed by the one or more processors, to cause the one or more processors to:
determine the one or more utilization metrics based at least in part on execution of a computer-executable task associated with one or more components of the multi-component system.

6. The apparatus of claim 1, wherein the instructions are further operable, when executed by the one or more processors, to cause the one or more processors to:
transform the interface definition data object into the server-based application based at least in part on a definition version identifier associated with the interface definition data object.

7. The apparatus of claim 1, wherein the instructions are further operable, when executed by the one or more processors, to cause the one or more processors to:
monitor the performance of the multi-component system based at least in part on one or more Service License Agreement (SLA) objectives associated with the application framework.

8. The apparatus of claim 1, wherein the instructions are further operable, when executed by the one or more processors, to cause the one or more processors to:
initiate the utilization of the server-based application based at least in part on a user input data object that defines one or more utilization behaviors associated with the server-based application.

9. The apparatus of claim 1, wherein the instructions are further operable, when executed by the one or more processors, to cause the one or more processors to:
execute the particular computer-executable task based at least in part on the server-based application.

10. The apparatus of claim 1, wherein the instructions are further operable, when executed by the one or more processors, to cause the one or more processors to:
initiate storage of the server-based application via a data repository that is accessible by one or more client devices communicatively coupled to the application framework.

11. The apparatus of claim 1, wherein the instructions are further operable, when executed by the one or more processors, to cause the one or more processors to:
retrieve the interface definition data object from a data repository that is accessible by one or more client devices communicatively coupled to the application framework.

12. A computer-implemented method, comprising:
receiving an interface definition data object that comprises a set of interface rules associated with managing communications between components of a multi-component system of an application framework;
determining a particular computer-executable task from a plurality of computable-executable tasks associated with the multi-component system of the application framework;
transforming the interface definition data object into a server-based application associated with a particular type of programming format from a plurality of programming formats based at least in part on (i) the set of interface rules and (ii) data associated with the particular computer-executable task;
initiating utilization of the server-based application via the multi-component system of the application framework; and
monitoring performance of the multi-component system based at least in part on the server-based application.

13. The computer-implemented method of claim 12, the computer-implemented method further comprising:
determining one or more utilization metrics associated with the utilization of the server-based application; and
initiating a rendering of a performance dashboard visualization via an electronic interface based at least in part on the one or more utilization metrics.

14. The computer-implemented method of claim 13, the computer-implemented method further comprising:
determining the one or more utilization metrics based at least in part on a definition version identifier associated with the server-based application.

15. The computer-implemented method of claim 13, the computer-implemented method further comprising:
determining the one or more utilization metrics based at least in part on the particular computer-executable task.

16. The computer-implemented method of claim 13, the computer-implemented method further comprising:
determining the one or more utilization metrics based at least in part on execution of a computer-executable task associated with one or more components of the multi-component system.

17. The computer-implemented method of claim 12, the computer-implemented method further comprising:
transforming the interface definition data object into the server-based application based at least in part on a definition version identifier associated with the interface definition data object.

18. The computer-implemented method of claim 12, the computer-implemented method further comprising:
monitoring the performance of the multi-component system based at least in part on one or more Service License Agreement (SLA) objectives associated with the application framework.

19. The computer-implemented method of claim 12, the computer-implemented method further comprising:
initiating the utilization of the server-based application based at least in part on a user input data object that defines one or more utilization behaviors associated with the server-based application.

20. A computer program product, stored on a computer readable medium, comprising instructions that when executed by one or more computers cause the one or more computers to:
receive an interface definition data object that comprises a set of interface rules associated with managing communications between components of a multi-component system of an application framework;
determine a particular computer-executable task from a plurality of computable-executable tasks associated with the multi-component system of the application framework;
transform the interface definition data object into a server-based application associated with a particular type of programming format from a plurality of programming formats based at least in part on (i) the set of interface rules and (ii) data associated with the particular computer-executable task; and
initiate utilization of the server-based application via the multi-component system of the application framework.
